(19) United States
(12) Patent Application Publication
(10) Pub. No.: US 2015/0280961 A1
(43) Pub. Date: Oct. 1, 2015

(54) NETWORK EXTENSION SYSTEM, CONTROL APPARATUS, AND NETWORK EXTENSION METHOD

(71) Applicant: Hitachi, Ltd., Tokyo (JP)

(72) Inventors: Ken Akune, Tokyo (JP); Junji Kinoshita, Tokyo (JP); Osamu Takada, Tokyo (JP)

(21) Appl. No.: 14/613,394

(22) Filed: Feb. 4, 2015

(30) Foreign Application Priority Data
Mar. 27, 2014 (JP) 2014-066398

(51) Int. Cl. H04L 12/24; H04L 29/08

(52) U.S. Cl. CPC H04L 41/02; H04L 67/10

(57) ABSTRACT

It is provided a network extension system configured to couple a first network system in which a first gateway and a first host computer are capable of communicating to and from each other to a second network system in which a second gateway and a second host computer are capable of communicating to and from each other, the second network system comprising a management apparatus, the network extension system comprising a control apparatus configured to control the management apparatus, the control apparatus being configured to execute: acquisition processing of acquiring network address information of the first host computer; and assignment processing of controlling the management apparatus to assign the network address information of the first host computer that has been acquired in the acquisition processing to the interface that is coupled to the second host computer among the group of interfaces of the second gateway.

### CLAIM OF PRIORITY

The present application claims priority from Japanese patent application JP 2014-66398 filed on Mar. 27, 2014, the content of which is hereby incorporated by reference into this application.

### BACKGROUND

The disclosed subject matter relates to a network extension system, control apparatus, and network extension method for extending a network to another network.

In recent years, for example, in order to speed up construction of a system or reduce maintenance and management costs of computer resources, the utilization of a data center for a cloud service or other uses is advancing. Further, progress is being made in a “hybrid cloud”, in which appropriate environments are combined with each other in an appropriate manner depending on its use from among a plurality of environments, such as a data center environment held by a cloud user such as a corporation or an organization (hereinafter referred to as “cloud user environment”) and a cloud environment provided by a service provider (hereinafter referred to as “cloud environment”).

In such a hybrid cloud, for example, to expand or transfer the cloud user's business operation system from the cloud user environment to the cloud environment, the configuration of a network through which communication of the cloud user flows (hereinafter referred to as “site network”) is changed in some cases.

In this configuration change, a virtual network is used, in which the site networks under individual environments can be virtually regarded as one network. For example, in a transmission control protocol (TCP)/internet protocol (IP) network, a virtual network technology such as a virtual private network (VPN) or a virtual extensible local area network (VXLAN) is used. With this technology, the cloud user can extend a local area network (LAN) of the cloud user environment to the cloud environment or other such

LANs while maintaining an IP address to expand or transfer the business operation system in a seamless manner. There have been known, for example, methods disclosed in U.S. Pat. No. 8,345,692 B2 and U.S. Pat. No. 8,166,205 B2 as such a virtual network technology for realizing the hybrid cloud.

The following technology is disclosed in U.S. Pat. No. 8,345,692 B2 (FIG. 1, FIG. 4, and the second, third, and fifth to seventh columns of Specification). Specifically, virtual switches for executing communication and transfer processing between an external network such as a wide area network (WAN) or the Internet and the site network are deployed to individual environments, to thereby realize the virtual network across the cloud user environment and the cloud environment.

In addition, the following technology is disclosed in U.S. Pat. No. 8,166,205 B2 (FIG. 1, FIG. 2, and the fourth to seventh columns of Specification). Specifically, edges each including a virtual switch are deployed to individual environments so that each of the edges autonomously learn network identification information for uniquely identifying a network of a host computer that is deployed under the edge (hereinafter referred to as “network address information”) and the network address information is shared autonomously among the edges, to thereby realize a virtual network across two or more data centers.

### SUMMARY

However, even if some or all of the methods disclosed in U.S. Pat. No. 8,345,692 B2 and U.S. Pat. No. 8,166,205 B2 described above are combined with each other, the site network of the cloud user environment cannot be extended to various cloud environments. For example, the site network extension is rejected depending on service specifications of the cloud environment. Specifically, in a case where a cloud platform manages, in this cloud environment, the network address information of a site network and a host computer within this cloud environment and only allows communication by the site network and the host computer, when the site network is extended from the cloud user environment to this cloud environment, the communication of the user's site network is disconnected because a network address of a host computer on the cloud user environment side is not registered in the cloud platform. The technologies disclosed in U.S. Pat. No. 8,345,692 B2 and U.S. Pat. No. 8,166,205 B2 cannot manage such a cloud environment, and the communication remains being disconnected.

The cloud environment in which the communication is disconnected as described above is hereinafter referred to as “constrained environment” and other types of cloud environment are hereinafter referred to as “unconstrained environment.” As described above, the related art has a problem in that the site network cannot be extended to the constrained environment to realize the hybrid cloud. The disclosure enables to extend a network to a constrained environment from outside of the constrained environment.

An aspect of the disclosure in this application is a network extension system configured to couple a first network system in which a first gateway and a first host computer are capable of communicating to and from each other to a second network system in which a second gateway and a second host computer are capable of communicating to and from each other, the second network system comprising a management apparatus configured to, when network address information of a transmission source of first data from outside of the second network system is not set to an interface that is coupled to the second host computer among a group of interfaces of the second gateway, discard the first data, and when network address information of a destination of second data from the second host computer is not set to the interface that is coupled to the second host computer among the group of interfaces of the second gateway, discard the second data, the network extension system comprising a control apparatus configured to control the management apparatus, the control apparatus being configured to execute: acquisition processing of acquiring network address information of the first host computer; and assignment processing of controlling the management apparatus to assign the network address information of the first host computer that has been acquired in the acquisition processing to the interface that is coupled to the second host computer among the group of interfaces of the second gateway.

According to the representative embodiment in the disclosure, it is possible to extend the network to the constrained environment from the outside of the constrained environment. Other objects, configurations, and effects than those described above are clarified by the following description of an embodiment.

The details of one or more implementations of the subject matter described in the specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is an explanatory diagram illustrating a network extension example according to a first embodiment.

FIG. 1B is an explanatory diagram illustrating a network address collection example in the hybrid cloud illustrated in FIG. 1A.

FIG. 2 is an explanatory diagram illustrating a system configuration example of the hybrid cloud.

FIG. 3 is an explanatory diagram illustrating a concept of a virtual network.

FIG. 4 is a block diagram illustrating a hardware and software configuration example of the gateway.

FIG. 5 is a block diagram illustrating a hardware and software configuration example of the gateway controller.

FIG. 6 is a block diagram illustrating a hardware and software configuration example of the cloud platform.

FIG. 7 is an explanatory diagram showing an example of the virtual network management table.

FIG. 8 is an explanatory diagram showing an example of the site network management table.

FIG. 9 is an explanatory diagram showing an example of the virtual network-site network association management table.

FIG. 10 is an explanatory diagram showing an example of the site network-site association management table.

FIG. 11 is an explanatory diagram showing an example of the site network-gateway association management table.

FIG. 12 is an explanatory diagram showing an example of the site network-host computer association management table.

FIG. 13 is an explanatory diagram showing an example of the cloud network information management table.

FIG. 14 is an explanatory diagram illustrating an example of data structures of the data F before being encapsulated and the data P after being encapsulated by VPN, VXLAN, GRE, or the like.

FIG. 15 is an explanatory diagram illustrating Message Example 1 to be exchanged between the gateway and the gateway controller.

FIG. 16 is an explanatory diagram illustrating Message Example 2 to be exchanged between the gateway and the gateway controller.

FIG. 17 is a sequence diagram each illustrating an example 1 of a network extension sequence.

FIG. 18 is a sequence diagram each illustrating an example 2 of a network extension sequence.

FIG. 19 is a flow chart illustrating an example of the network extension processing of Step S1806 illustrated in FIG. 18.

FIG. 20A is an explanatory diagram illustrating Network Extension Example 1 according to the second embodiment.

FIG. 20B is an explanatory diagram illustrating Network Extension Example 2 according to the second embodiment.

FIG. 21 is an explanatory diagram showing an example of the cloud network information management table according to the second embodiment.

FIG. 22 is an explanatory diagram illustrating an example of data structures before and after communication address conversion according to the second embodiment.

FIG. 23 is an explanatory diagram illustrating an example of a network extension flow according to the second embodiment.

### DETAILED DESCRIPTION OF THE PREFERRED EMBODIMENTS

Now, examples are described with reference to the accompanying drawings. It should be noted that the embodiments to be described below are not limitative of the present teachings.

### First Embodiment

### <Network Extension Example>

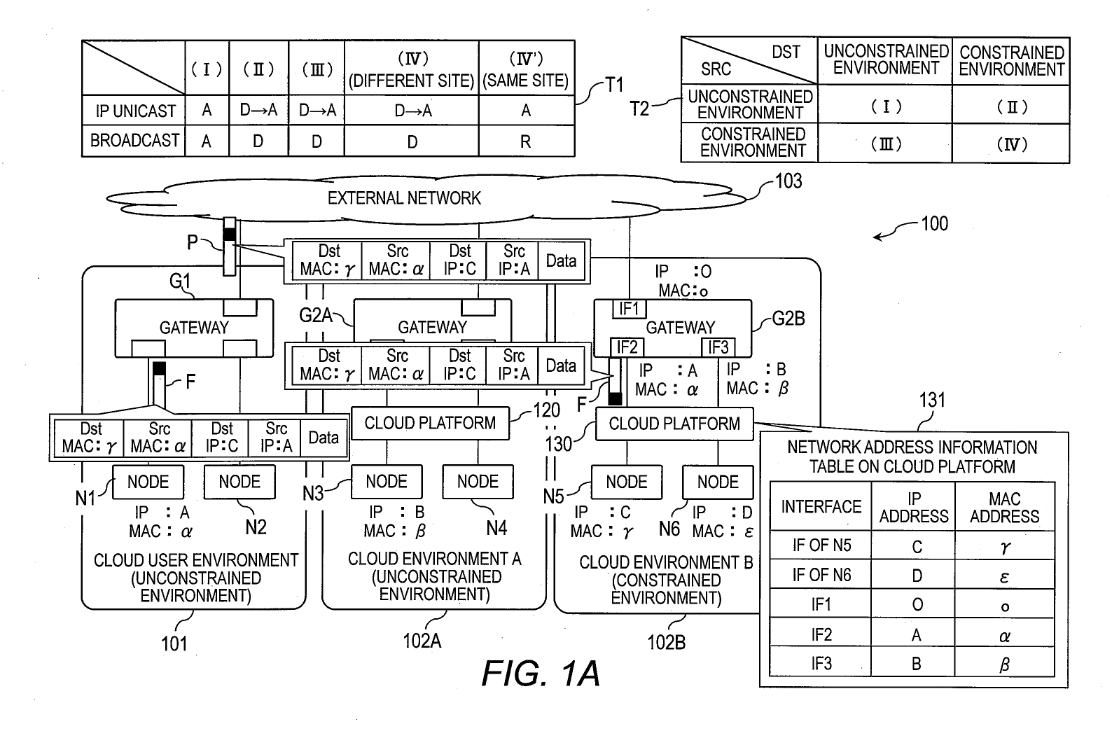

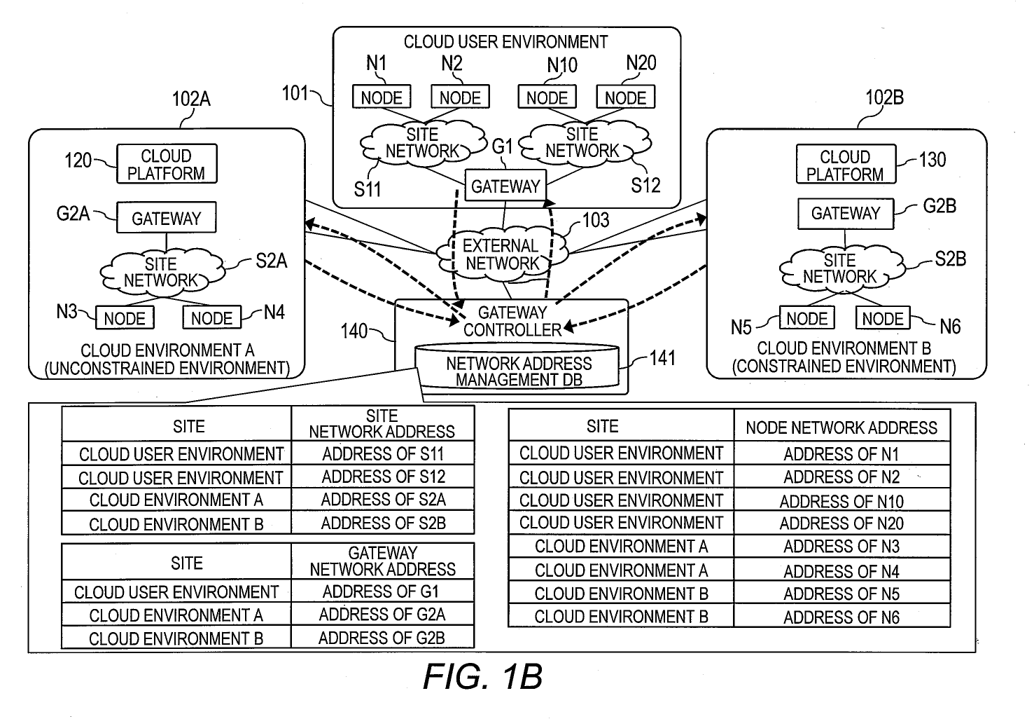

FIG. 1A is an explanatory diagram illustrating a network extension example according to a first embodiment. In FIG. 1A, a table T1 is a table showing whether unicast communication and broadcast communication under various environments are allowed, and a table T2 is a table showing combinations of environments of a transmission source and a destination. In the table T2, the constrained environment is, for example, a cloud environment having a constraint condition that broadcasting and spoofing are prohibited. “Spoofing” is an attack method in which a forged network address is assigned to a source network address and packets are sent to an attack target. For example, a case (III) represents a case where the transmission source has the constraint condition and the destination does not have the constraint condition.

In the table T1, “A” indicates that communication is allowed and “D” indicates that the packet is discarded by an access control function. Further, “R” indicates a case where the access control function makes a response by proxy. Moreover, “D→A” indicates a case where, although the packet is discarded by the access control function in the related art described above in the “BACKGROUND” section, the communication is made allowable by the first embodiment.

In a hybrid cloud 100 illustrated in FIG. 1A, a cloud user environment 101 that is a private cloud, a cloud environment 102A that is a public cloud, a cloud environment 102B that is a public cloud are coupled to one another via an external network 103 such as a WAN or the Internet. The hybrid cloud 100 is a system capable of executing network extension. In the description of the example of FIG. 1A, it is assumed that the cloud user environment 101 and the cloud environment 102A are each the unconstrained environment and the cloud environment 102B is the constrained environment.

The cloud user environment 101 is a network system that represents a site including a gateway G1 and nodes N1 and N2. It is assumed as an example that an IP address of the node N1 is “A” and an media access control (MAC) address thereof is “a.”

The cloud environment 102A is a network system that represents a site including a gateway G2A, a cloud platform 120, and nodes N3 and N4. The cloud platform 120 has a function of executing the network extension.

The cloud environment 102B is a network system that represents a site including a gateway G2B, a cloud platform 130, and nodes N5 and N6. The gateways G1, G2A, and G2B (collectively referred to as “gateways G”) transmit and receive data via the external network 103. The nodes N1 to N6 transmit data to other nodes included in its own site or nodes included in other sites, and receive data from the other nodes included in its own site or the nodes included in the other sites.

The cloud platform 130 is a management apparatus having an access control function and being configured to discard data under the above-mentioned constraint condition. Specifically, for example, the cloud platform 130 includes a network address information table 131 in which the IP address and the MAC address are associated with each other. The network address information table 131 is a table in which a network interface of the gateway G or a host computer H is assigned to a combination of the IP address and the MAC address that specify the node N or the gateway G. When a combination of a destination IP address and a destination MAC address of data does not exist in the network address information table 131, the cloud platform 130 discards this data.

A description is now given of respective cases of the table T1. A case (I) is a case where a transmission source and a destination are both the unconstrained environment. The case (I) corresponds to, for example, a case where data is transmitted from the node N1 to the node N3. In this case, the data from the node N1 (which may be transmitted by any of unicast and broadcast) passes through the gateway G1, the external network 103, the gateway G2A, and the cloud platform 120, to reach the node N3.

A case (II) is a case where the transmission source is the unconstrained environment and the destination is the constrained environment. The case (II) corresponds to, for example, a case where the packet is transmitted from the node N1 to the node N5. A description is given of, as an example, a case where data F is transmitted by unicast from the node N1 (source IP address: A, source MAC address: α) to the node N5 (destination IP address: C, destination MAC address: γ). The data F is encapsulated by the gateway G1 to become data P. This data P passes through the external network 103, and is decapsulated by the gateway G2B to return to the data F. This data F then reaches the cloud platform 130.

The cloud platform 130 refers to the network address information table 131 to determine whether or not a combination of the source IP address “A” and the source MAC address “α” included in the data F exists in the network address information table 131. In this example, this combination exits in the network address information table 131, and hence the data F is received by the node N5. As described above, it is possible to realize the network extension by assigning, to a network interface (IF2) of the gateway G2B of the constrained environment, network address information (IP address: A, MAC address: α) of the node other than those of the constrained environment.

It should be noted that the cloud environment 102B including the node N5 is the constrained environment, and hence when data from the node N1 is broadcast, the cloud platform 130 is to discard this broadcast data. Further, the example of the transmission from the node N1 to the node N5 is described above, but alternatively, the transmission source may also be any one of the nodes N2 to N4 and the destination may also be the node N6.

A case (III) is a case where the transmission source is the constrained environment and the destination is the unconstrained environment. The case (III) corresponds to, for example, a case where the data is transmitted from the node N5 to the node N1. A description is given of, as an example, a case where the data is transmitted by unicast from the node N5 (source IP address: C, source MAC address: γ) to the node N1 (destination IP address: A, destination MAC address: α). The cloud platform 130 refers to the network address information table 131 to determine whether or not a combination of the destination IP address “A” and the destination MAC address “α” included in the data from the node N5 exists in the network address information table 131. In this example, this combination exits in the network address information table 131, and hence the cloud platform 130 transfers the data from the node N5 to the gateway G2B without discarding the data. The gateway G2B encapsulates the received data. The encapsulated data passes through the external network 103, and is decapsulated by the gateway G1 to reach the node N1.

As described above, it is possible to realize the network extension by assigning, to the network interface (IF2) of the gateway G2B of the constrained environment, the network address information of the node other than those of the constrained environment (IP address: A, MAC address: α).

It should be noted that the cloud environment 102B including the node N5 is the constrained environment, and hence when data from the node N5 is broadcast, the cloud platform 130 is to discard this broadcast data. The example of the transmission from the node N5 to the node N1 is described above, but alternatively, the transmission source may also be the node N6 and the destination may also be any one of the nodes N2 to N4.

A case (IV) is a case where the transmission source and the destination are both the constrained environments and the constrained environment of the transmission source differs from the constrained environment of the destination. The case (IV) corresponds to, for example, a case where the packet is transmitted from a node under a constrained environment (not shown) to the node N5 and a case where the packet is transmitted from the node N5 to the node under the constrained environment (not shown).

In the case where the packet is transmitted from the node under the constrained environment (not shown) to the node N5, processing to be executed in the constrained environment (not shown) as the transmission side is similar to that of the case (III), and processing to be executed in the cloud environment 102B as the reception side is similar to that of the case (II).

In addition, in the case where the data is transmitted from the node N5 to the node under the constrained environment (not shown), processing to be executed in the cloud environment 102B as the transmission side is similar to that of the case (III), and processing to be executed in the constrained environment (not shown) as the reception side is similar to that of the case (II). In other words, as long as the network address information (IP address and MAC address) of the node under the constrained environment (not shown) exists in the network address information table 131, the node N5 can transmit the data by unicast to the node under the constrained environment (not shown), and can receive the data that has been unicast from the node under the constrained environment (not shown).

As described above, it is possible to realize the network extension by assigning, to the network interface of the gateway of the constrained environment, the network address information of the node other than those of the constrained environment.

It should be noted that the cloud environment 102B including the node N5 is the constrained environment, and hence when data from the node N5 is broadcast, the cloud platform 130 is to discard this broadcast data. Further, also when the data from the node under the constrained environment (not shown) is broadcast, the cloud platform 130 is to discard this broadcast data. The description given above takes the node N5 as an example, but the node N6 is also applicable.

A case (IV′) is a case where the transmission source and the destination are both the constrained environments and the constrained environment of the transmission source is the same as the constrained environment of the destination. The case (IV′) corresponds to, for example, a case where the data is transmitted from the node N5 to the node N6. When the data from the node N5 is unicast, as described above in the case (III), the data from the node N5 reaches the gateway G2B, but the data from the node N5 turns back at the gateway G2B and passes through the cloud platform 130 to reach the node N6. It should be noted that, when the data from the node N5 is broadcast, the cloud platform 130 makes a response by proxy to transmit this broadcast data to the node N6, but the broadcast data is not transmitted to the other nodes N1 to N4 and is discarded by the cloud platform 130.

### <Network Address Collection Example>

FIG. 1B is an explanatory diagram illustrating a network address collection example in the hybrid cloud illustrated in FIG. 1A. In order to assign the network address of a certain site (such as the cloud environment 102A or 102B) to the gateway G of another site (such as the cloud user environment 101), a gateway controller 140 needs to collect in advance the network addresses of the respective sites.

The cloud user environment 101 does not include the cloud platform, and hence the gateway G1 autonomously collects the network addresses of site networks S11 and S12 and nodes N1, N2, N10, and N20 within the cloud user environment 101. Specifically, for example, the gateway G1 has a learning function of learning the network address through use of ARP (such as OpenFlow (trademark) controller), and collects the source MAC addresses and source IP addresses (node network addresses) of the data transmitted from the nodes N1, N2, N10, and N20. Moreover, the gateway G1 specifies the network addresses (site network addresses) of the site networks S11 and S12 based on the collected source IP addresses.

Further, when the node N1 transmits the data to the node of another site (such as the cloud environment 102A or 102B), the MAC address of the node of the other site is unknown in some cases. In this case, when an ARP table held by the learning function of the gateway G1 has an entry that shows a combination of the MAC address and IP address of the node of the other site, the learning function of the gateway G1 refers to this entry and notifies the node N1 as the source of the data of this combination. In this manner, the node N1 can specify the combination of the MAC address and IP address of the node of the other site.

It is assumed that the cloud platform 120 of the cloud environment 102A holds in advance the network addresses of a site network S2A, the gateway G2A, the node N3, and the node N4. The site network means a network within its own site, and is, for example, a local area network (LAN) or a wide area network (WAN). In the same manner as in the gateway G1 of the cloud user environment 101, the gateway G2A may autonomously learn the network addresses of the site network S2A, the node N3, and the node N4 and register those network addresses in the cloud platform 120. It should be noted that, in the cloud platform 130, processing similar to that of the cloud platform 120 is executed.

The gateway controller 140 collects the network address information (site network addresses, node network addresses, and gateway network addresses) from the gateway G1 of the cloud user environment 101 and the cloud platforms 120 and 130 of the cloud environments 102A and 102B, and stores the collected network address information in a network address management DB 141. In other words, the gateway controller 140 manages the network address information in a centralized manner.

By then collecting the network address information of another site from the gateway controller 140, each of the gateways G can transmit the data by unicast from the node of its own site to the node of the other site as illustrated in FIG. 1A.

It should be noted that the gateway controller 140 collects the network address information of the respective sites in FIG. 1B, but each of the gateways G may collect, from the gateway G of another site, the network address information of the other site that has been acquired by the other site. When an autonomous sharing function is used among the gateways G in this manner, one of the gateways G functions as the gateway controller 140. Thus, by managing the network address information of the site networks S11, S12, S2A, and S2B and nodes N1 to N6, N10, and N20 through the autonomous sharing among the gateways G, it is possible to realize the network extension.

### <System Configuration Example>

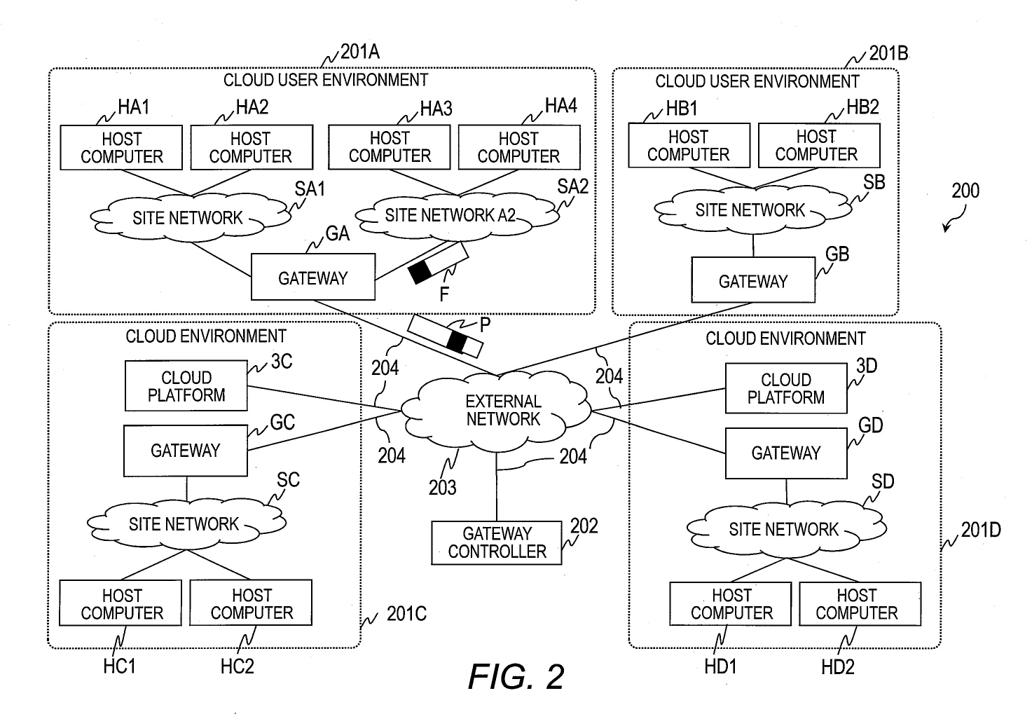

FIG. 2 is an explanatory diagram illustrating a system configuration example of the hybrid cloud. A hybrid cloud 200 includes cloud user environments 201A and 201B and cloud environments 201C and 201D (hereinafter collectively referred to as “sites 201”) and a gateway controller 202. The sites 201 and the gateway controller 202 are coupled to one another by communication lines 204 via an external network 203. In FIG. 2, the cloud user environments 201A and 201B each correspond to the private cloud and the cloud environments 201C and 201D each correspond to the public cloud. Further, at least one of the sites 201 is the above-mentioned constrained environment. Further, the number of each of the components within each site 201 may be 1, or may be 2 or more. Further, each of the number of the gateway controllers 202 and the number of the external networks 203 are not limited to 1, and may also be 2 or more.

Gateways GA to GD (hereinafter collectively referred to as “gateways G”) are network apparatus for relaying coupling between the external network 203 and site networks SA1, SA2, SB, SC, and SD (hereinafter collectively referred to as “site networks S”). The gateway G may be a physical apparatus or a virtual apparatus. The gateway G uses a known virtual network technology to encapsulate communication data in the site network and transmit the encapsulated data to the external network 203. Examples of the known virtual network technology include a virtual private network (VPN), generic routing encapsulation (GRE), and a virtual extensible local area network (VXLAN).

Further, the gateway G includes a virtual switch (not shown), and executes communication and transfer processing, communication address conversion processing, and communication learning processing between the external network 203 and the site network S. The gateway G executes the communication and transfer processing in response to a request from the gateway controller 202. Further, the gateway G converts a destination network address and source network address of the packet in response to a request from the gateway controller 202. The communication learning processing is processing of collecting the network addresses of host computers HA1 to HA4, HB1, HB2, HC1, HC2, HD1, and HD2 (hereinafter collectively referred to as “host computers H”) that are deployed under the respective gateways G.

The communication learning processing can be implemented by a technology of programming the configuration and function of the network by software. Examples of the technology of programming the configuration and function of the network by software include OpenFlow (trademark) in which the source network address of an address resolution protocol (ARP) request of the host computer H is used for learning and other known methods, and a proprietary method.

The gateway controller 202 is a control apparatus for controlling the gateways G in a centralized manner and managing the entire hybrid cloud 200 in a centralized manner. For example, the gateway controller 202 controls one or more gateways G in a centralized manner via the external network 203 or the site networks S and manages the network address information of the site networks S and the host computers H in a centralized manner via the gateways G or cloud platforms 3C and 3D (hereinafter collectively referred to as “cloud platforms 3”). Further, the gateway controller 202 may be deployed in any one of the sites 201 as long as the gateway controller 202 is deployed in such an environment as to enable communication to and from the gateways G.

The gateway controller 202 may be any of a physical machine and a virtual machine. In a case where the gateway controller 202 is the virtual machine, the gateway controller 202 is built in, for example, any one of the gateways G or any one of the cloud platforms 3. In other words, in a case where the gateway controller 202 is built in the gateway G, the gateway G substantially functions as the gateway controller 202 as well, and in a case where the gateway controller 202 is built in the cloud platform 3, the cloud platform 3 substantially functions as the gateway controller 202 as well.

The cloud platforms 3 are apparatus for managing the site networks S and host computers H of the cloud environments 201C and 201D, and may each include a management interface (not shown) for providing information on the site network S and the host computer H and making settings therefor. The management interface is implemented by, for example, an application programming interface (API). In a case where the cloud platform 3 includes the management interface, for example, in response to a request from outside such as a cloud user or the gateway controller 202, the cloud platform 3 can provide the information on the site network S and the host computer H, create the gateway G, and set the network addresses.

The host computer H is a computer for communicating to and from other host computers H of its own site 201 and the host computers H of the other sites 201. The host computer H corresponds to the node illustrated in FIG. 1A and FIG. 1B. The host computer H may be any of a physical machine and a virtual machine.

The external network 203 is a network through which communication across two or more sites 201 flows, and is, for example, a WAN or the Internet. The site network S is a network through which the packets from the host computer H flow. The site network S is, for example, a LAN or a WAN, and may exist across a plurality of data centers.

The cloud user environments 201A and 201B are each a data center environment held by the cloud user, and in this embodiment, as an example, are assumed to be a data center environment held by the same cloud user. The cloud environment 201C is the unconstrained environment, and is, for example, the cloud environment in which the site network S can be extended by a known technology. The cloud environment 201D is the constrained environment, and is, for example, the cloud environment in which the site network extension using the known technology is rejected. The data F is data before being encapsulated, which flows through the site network S. The data P is data obtained after encapsulation of the data F.

### <Concept of Virtual Network>

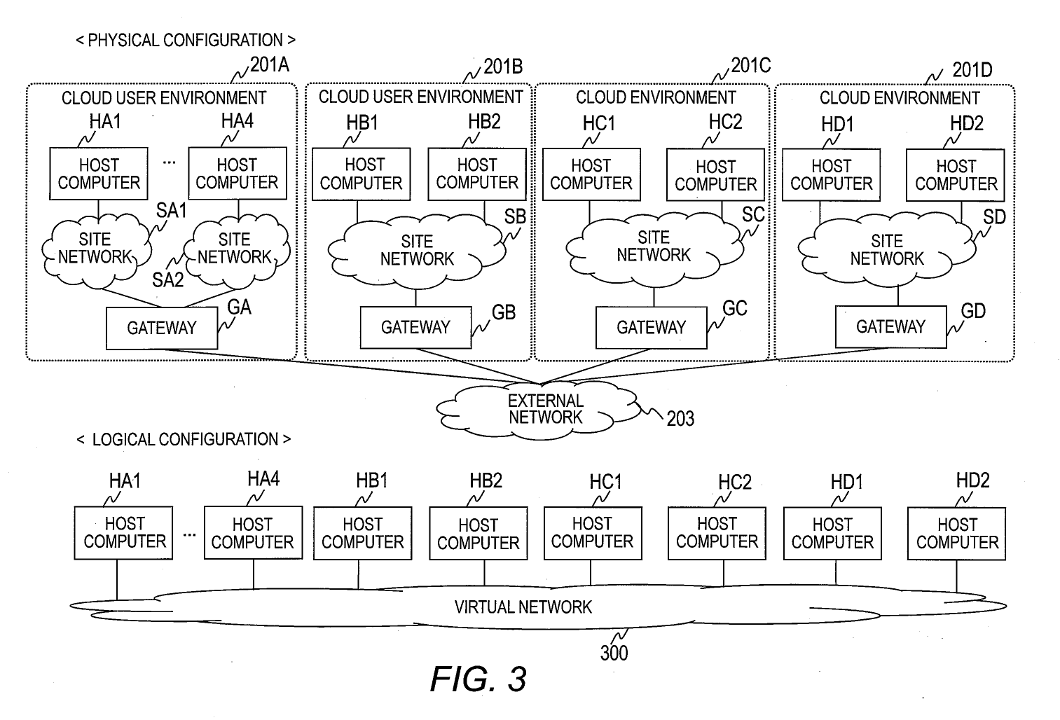

FIG. 3 is an explanatory diagram illustrating a concept of a virtual network. A virtual network 300 is such a concept that the site networks S of the individual sites 201 are virtually regarded as one network. As compared with a physical configuration, the virtual network 300 is a network in which the gateways G and the site networks S are consolidated. For example, in a TCP/IP network, the cloud user extends the LANs of the cloud user environments 201A and 201B to the LANs of the cloud environments 201C and 201D while maintaining an IP address system. In this manner, it is possible to expand and transfer the business operation system in a seamless manner. It should be noted that the virtual network 300 is not limited to this example, and may also be a network in which one or more of the site networks S are consolidated. Further, a network extension target from the gateway G may be selected in units of virtual networks, or may be selected in units of sites. TCP/IP network is taken as an example in the embodiment. The embodiment is also applicable to other networks such as ATM network.

### <Configuration Example of Gateway G>

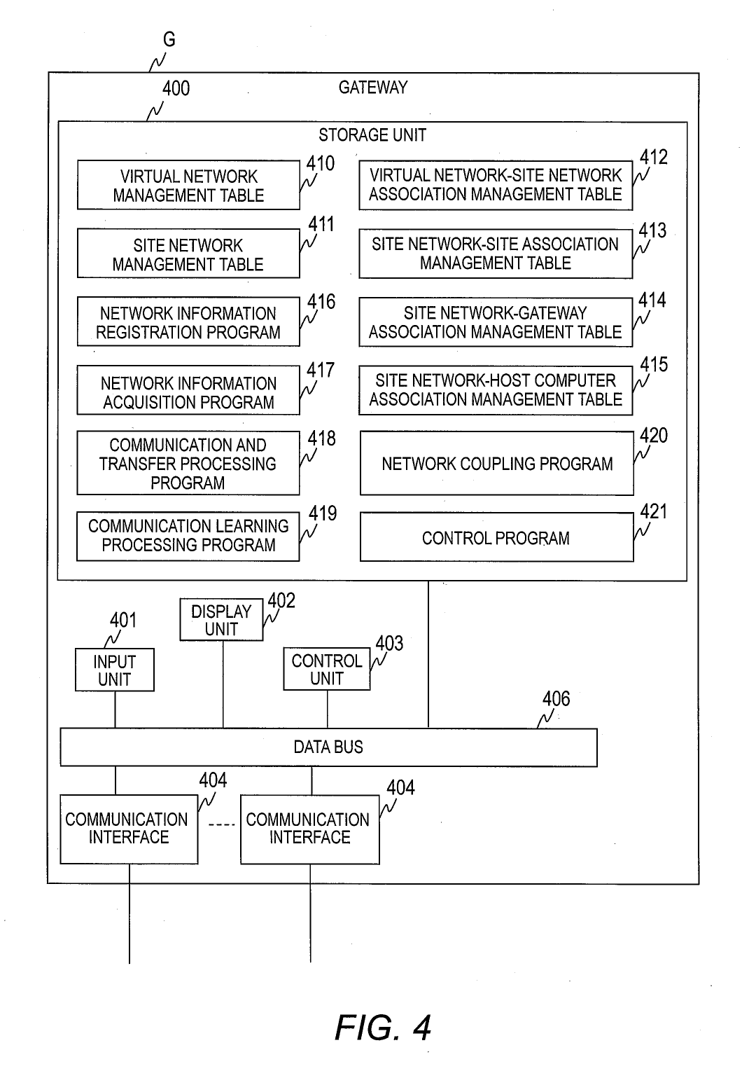

FIG. 4 is a block diagram illustrating a hardware and software configuration example of the gateway G. The gateway G can be formed of a storage unit 400, an input unit 401, a display unit 402 such as a CRT display or a liquid crystal display, a control unit 403 that is a processor, communication interfaces 404 for coupling to the external network 203 and the site network S, and a data bus 406 for coupling those components to one another.

The storage unit 400 stores a virtual network management table 410, a site network management table 411, a virtual network-site network association management table 412, a site network-site association management table 413, a site network-gateway association management table 414, and a site network-host computer association management table 415. The storage unit 400 further stores a network information registration program 416, a network information acquisition program 417, a communication and transfer processing program 418, a communication learning processing program 419, a network coupling program 420, and a control program 421.

It should be noted that the following description is given by using a “program” as a subject (operation subject) in some cases, but may be given by using a processor as the subject because the program executes predetermined processing by being executed by the processor while using a memory and a communication port (communication control apparatus). Further, a part or all of the programs may be implemented by dedicated hardware, or may be modularized. Various programs may also be installed onto each computer by a program distribution server or via a storage medium.

The virtual network management table 410 is a table for storing information uniquely specifying the virtual network 300. The virtual network management table 410 is a table created by the cloud user. The gateways GC and GD of the cloud environments 201C and 201D therefore do not have the virtual network management tables 410.

The site network management table 411 is a table for storing information on the site network S. The gateway G creates the site network management table 411 by collecting the information on the site network S of its own site.

The virtual network-site network association management table 412 is a table in which information on the virtual network 300 and information on the site network are associated with each other. The virtual network-site network association management table 412 associates the virtual network management table 410 and the site network management table 411 with each other. With this, the gateway G manages its coupling state to the site network S belonging to the virtual network 300 that has been selected as the network extension target.

The site network-site association management table 413 is a table in which the information on the site network S and information on the site 201 are associated with each other. With this, it is possible to specify which of the sites 201 includes which of the site networks S.

The site network-gateway association management table 414 is a table in which the information on the site network S and information on the gateway G are associated with each other. The site network-gateway association management table 414 is a table created when, for example, the gateway controller 202 collects the network information of the respective sites 201 as illustrated in FIG. 1B.

The site network-host computer association management table 415 is a table in which the information on the site network and information on the host computer are associated with each other. With this, it is possible to specify which of the site networks S is connected to which of the host computers H.

The network information registration program 416 is a program for registering the network address information of the site network S and the host computer H in the gateway controller 202. The network information acquisition program 417 is a program for controlling the gateway G to request, from the gateway controller 202, the information on the virtual network 300 and the network addresses of the site network S and the host computer H.

The communication and transfer processing program 418 is a program for controlling the gateway G to execute communication and transfer processing in response to a request from the gateway controller 202. The communication learning processing program 419 is a program for collecting the network address information of the host computer H. For example, when the gateway G receives an ARP request from the host computer H, the gateway G collects the network address information of the host computer H with the use of the source network address information.

Further, the communication and transfer processing program 418 refers to an IP address column of the site network-host computer association management table 415 to specify the MAC address corresponding to the source IP address of the received ARP request, and notifies the host computer H of the specified MAC address as an ARP response. This processing is merely an example, and any protocol can be applicable as long as the gateway G can collect the network address information of the host computer H.

The network coupling program 420 is a program for requesting the gateway controller 202 to execute coupling or decoupling to or from the site network requested by the cloud user. The control program 421 is a program, such as VPN or VXLAN, for encapsulating communication in response to a request from the gateway controller 202. Further, the control program 421 controls the gateway G to execute the coupling or decoupling in response to a request from the gateway controller 202.

It should be noted that, when the gateway G is deployed as the virtual machine, a deployment target of the virtual machine (such as the cloud platform 3) acquires the above-mentioned programs 416 to 421 from the gateway controller 202. As described later, the gateway controller 202 includes the programs 416 to 421. In this manner, it is possible to build the gateway at the site 201 that does not include the gateway G.

### <Configuration Example of Gateway Controller 202>

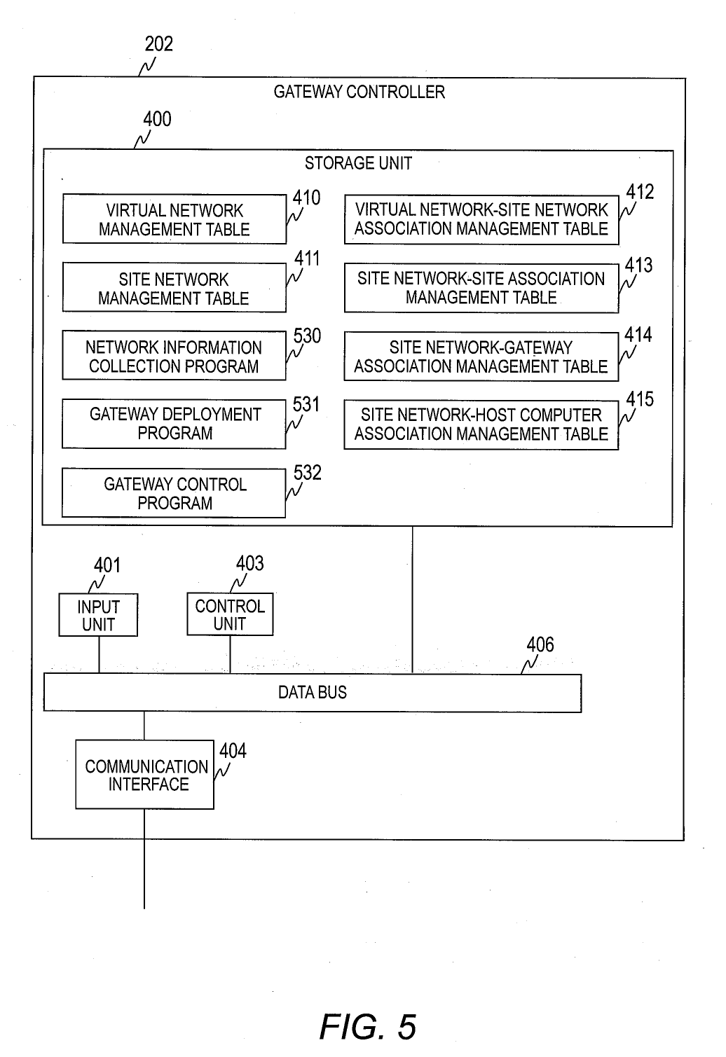

FIG. 5 is a block diagram illustrating a hardware and software configuration example of the gateway controller 202. The same components as those of FIG. 4 are denoted with the same reference numerals, and a description thereof is omitted. A network information collection program 530 is a program for requesting, from the cloud platform 3, the network address information of the site network S and the host computer H.

A gateway deployment program 531 is a program for requesting, in response to a request from the gateway G, the cloud platform 3 to deploy the gateway G to the site network S of the cloud environment 201C or 201D, and requesting setting of the network address to the gateway G that has been deployed. A gateway control program 532 is a program for collecting the network address information of the site network S and the host computer H that has been collected by the gateway G, instructing the gateway G to execute the coupling or decoupling, and adding or deleting a rule for the communication and transfer processing to or from the gateway G. It should be noted that the management tables 411 and 413 to 415 correspond to the network address management DB 141 illustrated in FIG. 1B.

### <Configuration Example of Cloud Platform 3>

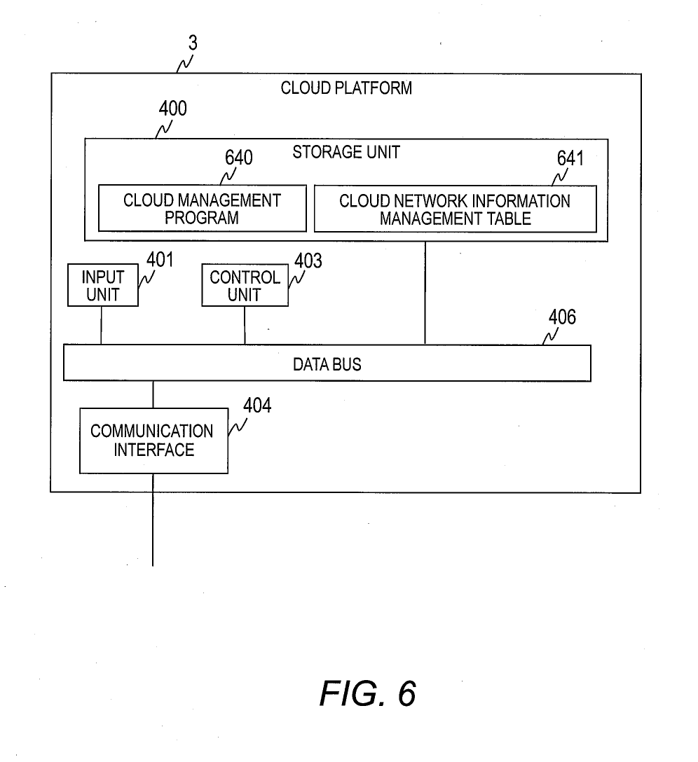

FIG. 6 is a block diagram illustrating a hardware and software configuration example of the cloud platform 3. The same components as those of FIG. 4 are denoted with the same reference numerals, and a description thereof is omitted. A cloud management program 640 is a program for referring to, in response to a request from the gateway controller 202, a cloud network information management table 641 to notify the gateway controller 202 of the network addresses of the site network S and the host computer H. The cloud management program 640 is also a program for deploying the gateway G in response to a request from an external apparatus such as the gateway controller 202.

The cloud network information management table 641 is a table for storing the network addresses of the gateways G and the host computers H, which are the virtual machines in the cloud environments 201C and 201D. The cloud network information management table 641 corresponds to the network address information table 131 illustrated in FIG. 1A. Further, the cloud platform 3D of the cloud environment 201D that is the constrained environment transfers or blocks the data based on the information of the cloud network information management table 641.

### <Virtual Network Management Table 410>

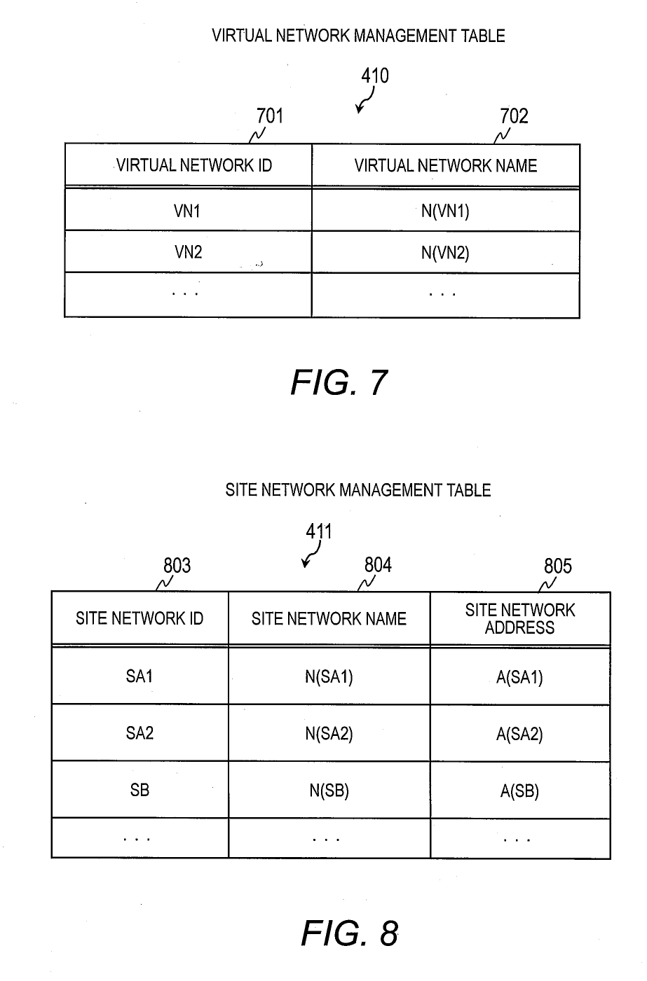

FIG. 7 is an explanatory diagram showing an example of the virtual network management table 410. The virtual network management table 410 is information associating a virtual network ID 701 and a virtual network name 702 with each other. The virtual network ID 701 is information uniquely identifying the virtual network 300. The virtual network name 702 is the name of the virtual network 300, and is information that is recognizable by the cloud user. An entry in a first row of the virtual network management table 410 shows, for example, that the virtual network name 702 of a virtual network VN1 whose virtual network ID 701 is “VN1” is “N(VN1).”

### <Site Network Management Table 411>

FIG. 8 is an explanatory diagram showing an example of the site network management table 411. The site network management table 411 is information associating a site network ID 803, a site network name 804, and a site network address 805 with one another. The site network ID 803 is information uniquely identifying the site network S. The site network name 804 is the name of the site network S, and is information that is recognizable by the cloud user. The site network address 805 is the network address of the site network S. An entry in a first row of the site network management table 411 shows, for example, that the site network name 804 of a site network SA1 whose site network ID 803 is “SA1” is “N(SA1)” and the site network address 805 thereof is “A(SA1).”

The gateway G autonomously learns the entry for the site network S of its own site 201 and acquires the entries for the site networks S of the other sites 201 from the gateway controller 202. Further, as illustrated in FIG. 1B, the gateway controller 202 merges the entries of the site network management table 411 that are collected from the respective sites 201, and registers the resultant in the site network management table 411 of the gateway controller 202.

### <Virtual Network-Site Network Association Management Table 412>

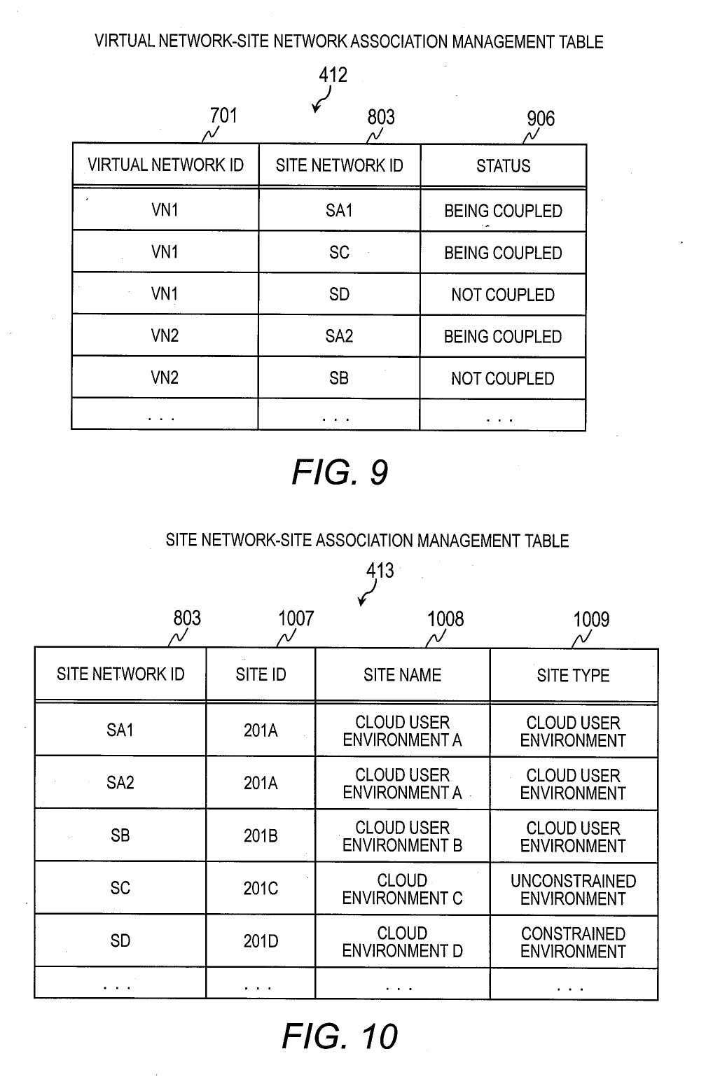

FIG. 9 is an explanatory diagram showing an example of the virtual network-site network association management table 412. The virtual network-site network association management table 412 is information associating the virtual network 300 and the site network S with each other, and specifically is, for example, information associating the virtual network ID 701, the site network ID 803, and a status 906 with one another.

The status 906 stores a coupling status of the site network S specified by the site network ID 803. Specifically, a set of values of the site network IDs 803 of the entries whose values of the virtual network IDs 701 are the same and whose statuses 906 are each “Being Coupled” is the site networks S that are coupled to one another as the virtual network 300. For example, the site networks of a group of entries whose virtual network IDs are each “VN1” are “SA1,” “SC,” and “SD,” and of those site networks, the site networks S whose statuses are each “Being Coupled” are “SA1” and “SC.” The site networks SA1 and SC therefore correspond to the virtual network 300 in which those site networks are coupled to one another as the virtual network VN1.

The gateway G refers to the value of the status 906 to couple or decouple the communication. The value of the status 906 is “Not Coupled” by default, but is updated to “Being Coupled” for the virtual network VN for which a coupling request is made as the network extension target, and then updated to “Not Coupled” when a decoupling request for the corresponding virtual network VN is made. It should be noted that the coupling request and decoupling request for the network extension target are made not only in units of the virtual networks VN but also in units of the site networks S, and hence in FIG. 9, in the virtual network VN1, the site networks SA1 and SC are “Being Coupled” and the site network SD is “Not Coupled.”

### <Site Network-Site Association Management Table 413>

FIG. 10 is an explanatory diagram showing an example of the site network-site association management table 413. The site network-site association management table 413 is information associating the site 201 and the site network S with each other, and specifically is, for example, information associating a site network ID 1007, a site name 1008, and a site type 1009 with one another.

The site ID 1007 is information uniquely identifying the site 201. The site name 1008 is the name of the site 201, and is information that is recognizable by the cloud user. The site type 1009 is information for identifying whether the site 201 is the constrained environment or the unconstrained environment. An entry in a first row of the site network-site association management table 413 shows, for example, that the site network SA1 whose site network ID 803 is “SA1” is a network within the cloud user environment 201A having the site ID of “201A,” the site name 1008 of “Cloud User Environment A,” and the site type 1009 of “Cloud User Environment.”

The gateway G autonomously learns the entry of its own site 201 for the site network S and the site 201 and associates the acquired items of the entry with one another, and acquires the entries of the other sites 201 for the site networks S and other sites 201 from the gateway controller 202.

Further, as illustrated in FIG. 1B, the gateway controller 202 merges the entries of the site network-site association management tables 413 that are collected from the respective sites 201, and registers the resultant in the site network-site association management table 413 of the gateway controller 202.

### <Site Network-Gateway Association Management Table 414>

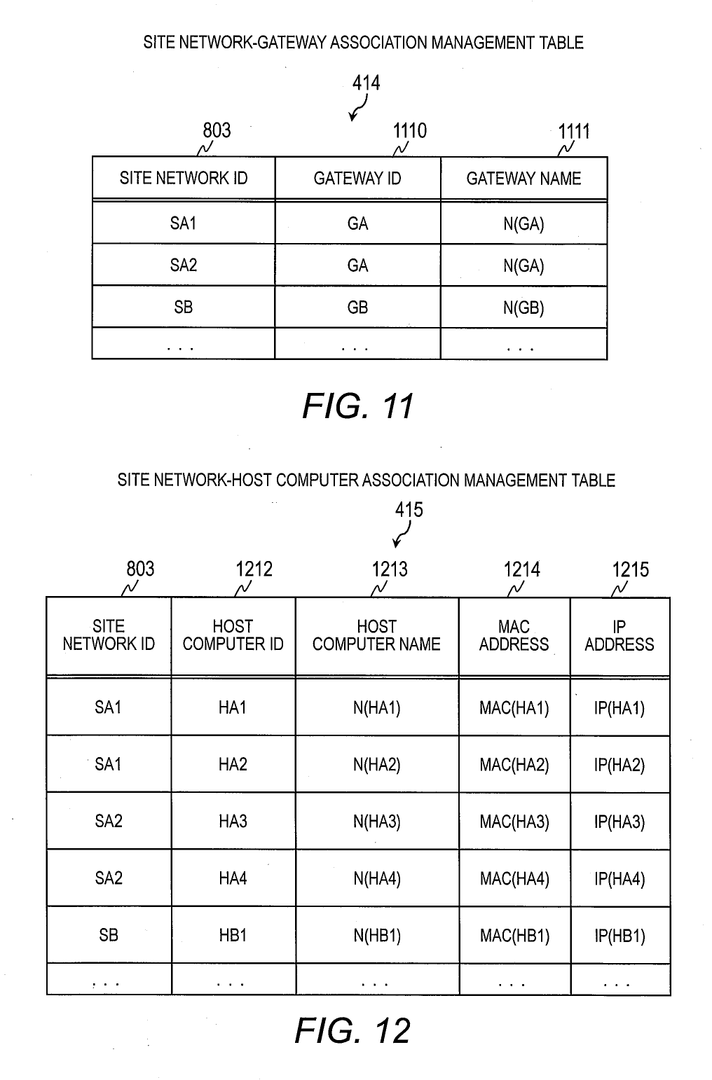

FIG. 11 is an explanatory diagram showing an example of the site network-gateway association management table 414. The site network-gateway association management table 414 is information associating the site network S and the gateway G with each other, and specifically is, for example, information associating the site network ID 803, a gateway ID 1110, and a gateway name 1111 with one another. The gateway ID 1110 is information uniquely identifying the gateway G. The gateway name 1111 is the name of the gateway G, and is information that is recognizable by the cloud user.

An entry in a first row of the site network-gateway association management table 414 shows, for example, that the gateway GA having the gateway ID 1110 of “GA” and the gateway name 1111 of “N(GA)” is coupled to the site network SA1 having the site network ID 803 of “SA1.”

The gateway G autonomously learns the entry of its own site 201 for the site network ID 803, the gateway ID 1110, and the gateway name 1111 and associates the acquired items of the entry with one another, and acquires the entries of the other sites 201 for the site network ID 803, the gateway ID 1110, and the gateway name 1111 from the gateway controller 202.

Further, as illustrated in FIG. 1B, the gateway controller 202 merges the entries of the site network-gateway association management table 414 that are collected from the respective sites 201, and registers the resultant in the site network-gateway association management table 414 of the gateway controller 202.

### <Site Network-Host Computer Association Management Table 415>

FIG. 12 is an explanatory diagram showing an example of the site network-host computer association management table 415. The site network-host computer association management table 415 is information associating the site network S and the host computer H with each other, and specifically is, for example, information associating the site network ID 803, a host computer ID 1212, a host computer name 1213, a MAC address 1214, and an IP address 1215 with one another.

The host computer ID 1212 is information uniquely identifying the host computer H. The host computer name 1213 is the name of the host computer H, and is information that is recognizable by the cloud user. The MAC address 1214 and the IP address 1215 are the network address information of the host computer H.

An entry in a first row of the site network-host computer association management table 415 shows, for example, that the host computer HA1 having the host computer ID 1212 of “HA1,” the host computer name 1213 of “N(HA1),” the MAC address 1214 of “MAC(HA1),” and the IP address 1215 of “IP(HA1)” is coupled to the site network SA1 having the site network ID 803 of “SA1.”

The gateway G autonomously learns the entry of its own site 201 for the site network S and the host computer H and associates the acquired items of the entry with one another, and acquires the entries of the other sites 201 for the site network S and the host computer H from the gateway controller 202.

Further, as illustrated in FIG. 1B, the gateway controller 202 merges the entries of the site network-host computer association management table 415 that are collected from the respective sites 201, and registers the resultant in the site network-host computer association management table 415 of the gateway controller 202.

### <Cloud Network Information Management Table 641>

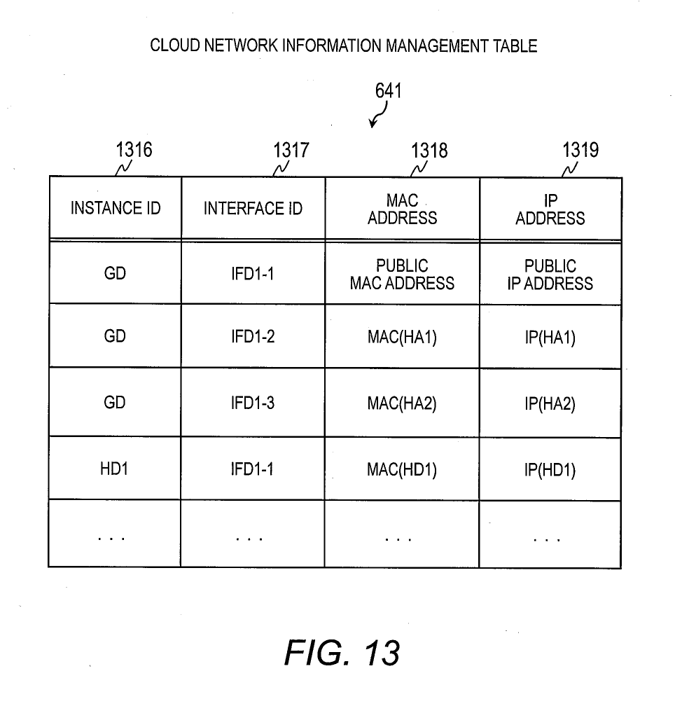

FIG. 13 is an explanatory diagram showing an example of the cloud network information management table 641. The cloud network information management table 641 is information managing the network address information of the virtual machine built on the cloud platform 3, and specifically is, for example, information associating an instance ID 1316, an interface ID 1317, a MAC address 1318, and an IP address 1319 with one another. The instance ID 1316 is information to be used by the cloud platform 3 to uniquely identify the gateway G or host computer H to become an instance. One or more interfaces are assigned to each instance. The interface ID 1317 is information to be used by the cloud platform 3 to uniquely identify the interface of the instance ID 1316, and each interface may include one MAC address and one or more IP addresses. The MAC address 1318 and the IP address 1319 are addresses assigned to the interface ID 1317.

In FIG. 13, an entry having the gateway ID as the instance ID 1316 shows the gateway G as the virtual machine that is built in the cloud environment to which the corresponding cloud platform 3 belongs. Further, an entry having the host computer ID as the instance ID 1316 shows the host computer H as the virtual machine that is built in the cloud environment to which the corresponding cloud platform 3 belongs. The entry having the gateway ID as the instance ID 1316 is, as described later, set when a request to deploy the gateway is made from the gateway controller 202.

Then, when the gateway G that is the virtual machine is deployed, the cloud platform 3 sets the network address information (interface ID 1317, MAC address 1318, and IP address 1319) of the gateway G in the entry of the deployed gateway G. Further, to acquire the network address information (interface ID 1317, MAC address 1318, and IP address 1319) of the host computer H of its own site 201, the cloud platform 3 acquires, from the gateway G, the network address information of the host computer H that has been learned by the gateway G using ARP. Further, the cloud platform 3 acquires the network address information of the gateways G and the host computers H of the other sites 201 from the gateway controller that has collected this information.

It should be noted that the cloud network information management table 641 manages the network address information of the gateway G and the host computer H that are the virtual machines, and does not manage the network address information of the gateway G and the host computer H that are the physical machines.

To manage the network address information of the gateway G and the host computer H that are the physical machines, the gateway G that is the physical machine manages this network address information with the use of a table similar to the cloud network information management table 641. In other words, also in the case of the physical machine, to acquire the network address information (interface ID 1317, MAC address 1318, and IP address 1319) of the host computer H of its own site 201, the gateway G acquires the network address information of the host computer H that has been learned by using ARP. Further, the gateway G acquires the network address information of the gateways G and the host computers H of the other sites 201 from the gateway controller 202 that has collected this information.

It should be noted that the network address information of the gateway G and the host computer H that are the physical machines may also be acquired by the cloud platform 3 from the gateway G of its own site 201 so that the cloud platform 3 stores the acquired network address information in the cloud network information management table 641 for management.

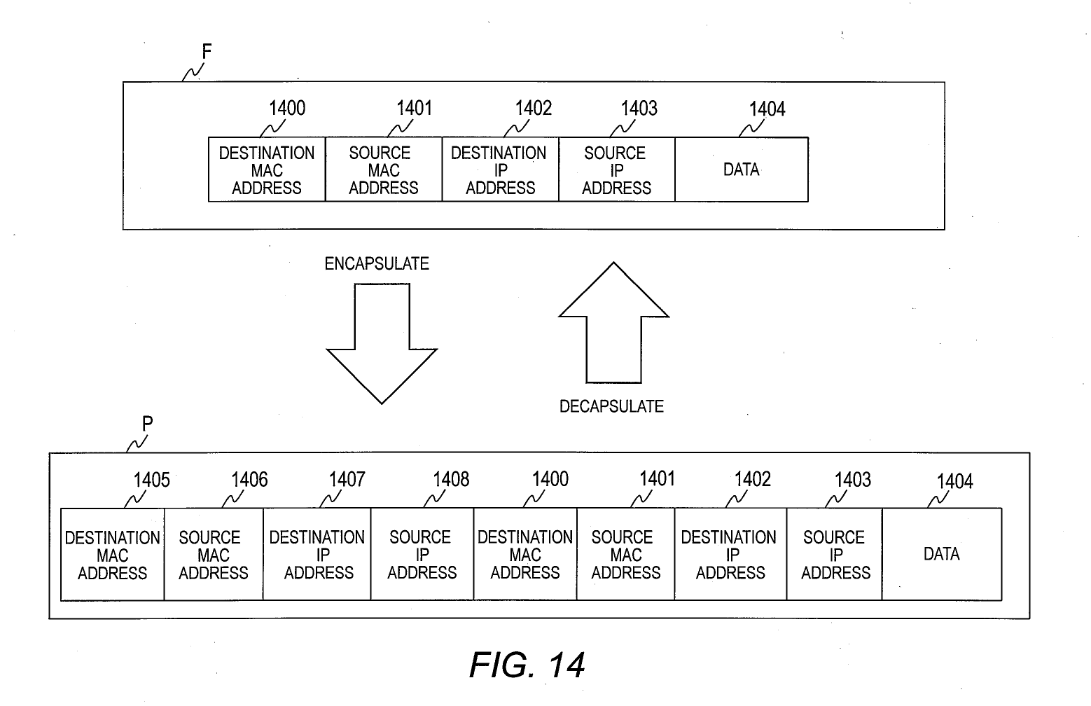

FIG. 14 is an explanatory diagram illustrating an example of data structures of the data F before being encapsulated and the data P after being encapsulated by VPN, VXLAN, GRE, or the like. The data F is a general Ethernet communication frame before being encapsulated and the data P shows an example of a packet obtained after the frame is encapsulated with an IP communication packet.

A destination MAC address 1400 and a destination IP address 1402 are fields for storing network identification information for uniquely identifying a communication counterpart on a network. A source MAC address 1401 and a source IP address 1403 are fields for storing network identification information for uniquely identifying a communication source on the network. A data 1404 is a field for storing arbitrary data to be exchanged with the communication counterpart. A destination MAC address 1405 and a destination IP address 1407 are fields for storing the network identification information for uniquely identifying the communication counterpart on the network after the frame is encapsulated. A source MAC address 1406 and a source IP address 1408 are fields for storing the network identification information for uniquely identifying the communication source on the network after the frame is encapsulated.

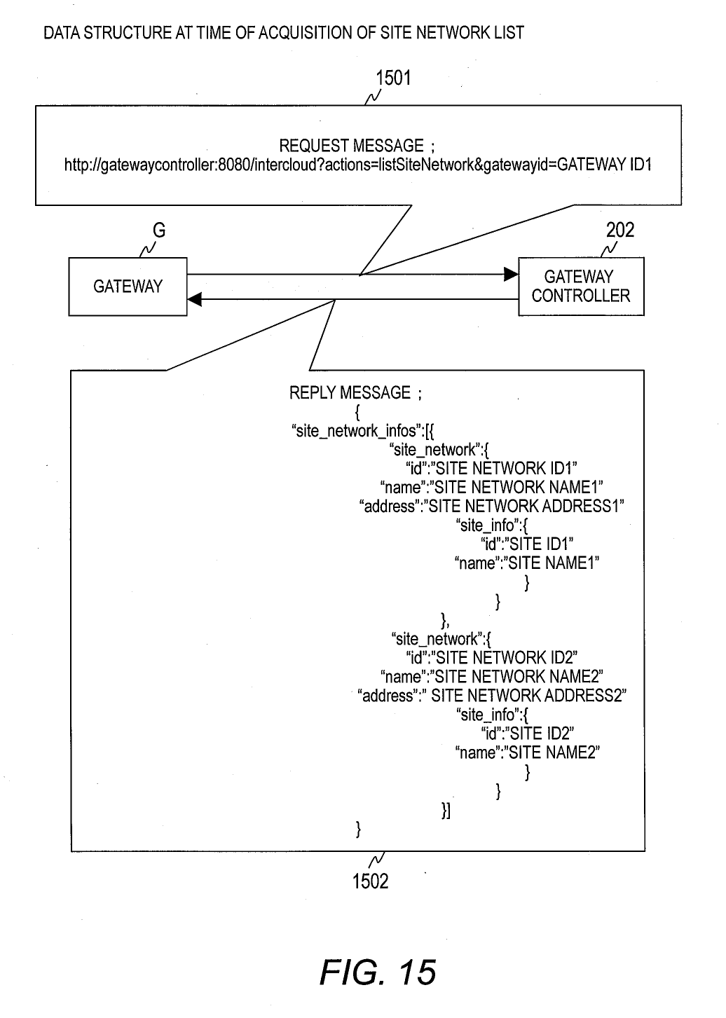

FIG. 15 is an explanatory diagram illustrating Message Example 1 to be exchanged between the gateway G and the gateway controller 202. FIG. 15 illustrates a request for a configuration list that is issued by the gateway G to the gateway controller 202, and a response to this request. The configuration list is, for example, a list of the virtual networks 300, a list of the site networks S, or a list of the host computers H.

A request message 1501 is a message with which the gateway G issues a request for a site network list to the gateway controller 202. The message 1501 is transmitted via a command line interface (CLI), a graphical user interface (GUI), an API, or the like. A protocol for transmission may be a known protocol such as Secure Shell (SSH) or Hypertext Transfer Protocol (HTTP), or may be a proprietary protocol.

A reply message 1502 is a message showing a response to the message 1501. The format of the message 1502 may be a known format such as JSON, or may be a proprietary format. FIG. 15 illustrates HTTP and JavaScript Object Notation (JSON) as an example, but this embodiment is not limited to a specific protocol and format.

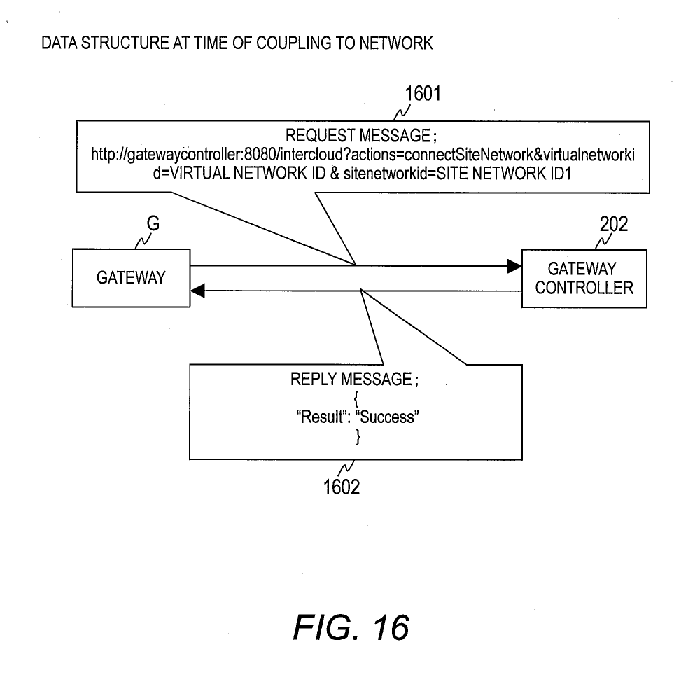

FIG. 16 is an explanatory diagram illustrating Message Example 2 to be exchanged between the gateway G and the gateway controller 202. FIG. 16 illustrates a request for coupling to an arbitrary site network S by the gateway G to the gateway controller 202, and a response to this request. A request message 1601 is transmitted via a CLI, a GUI, an API, or the like. A protocol for transmission may be a known protocol such as SSH or HTTP, or may be a proprietary protocol. A reply message 1602 is a message showing a response to the message 1601. The format of the message 1602 may be a known format such as JSON, or may be a proprietary format. FIG. 16 illustrates HTTP and JSON as an example, but this embodiment is not limited to a specific protocol and format.

### <Network Extension Sequence>

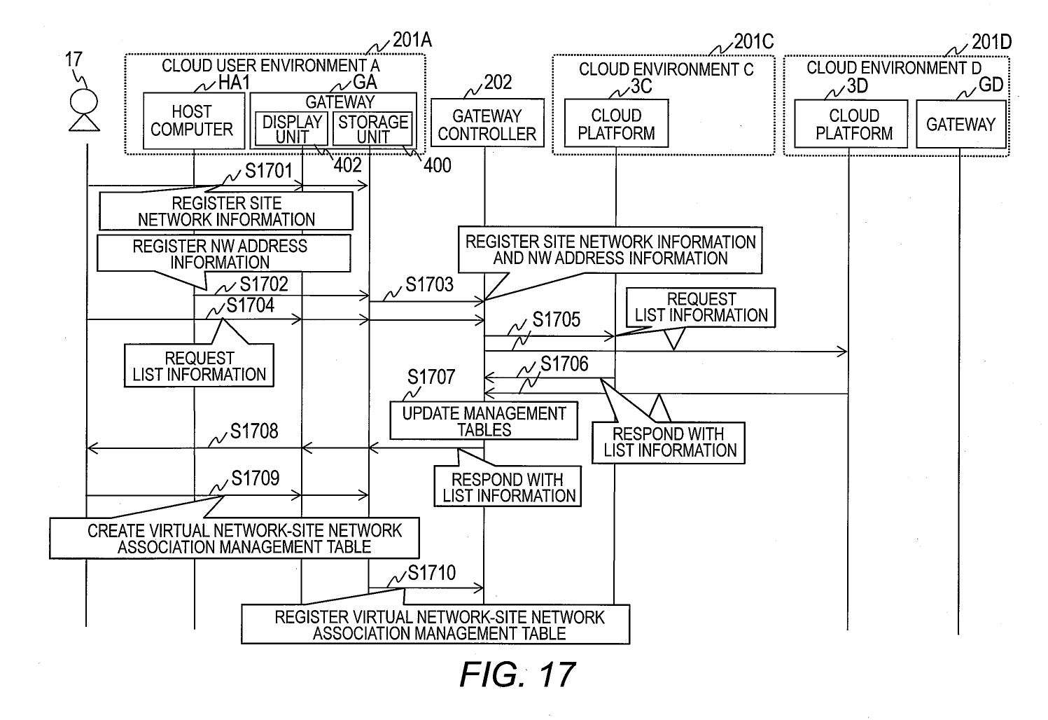

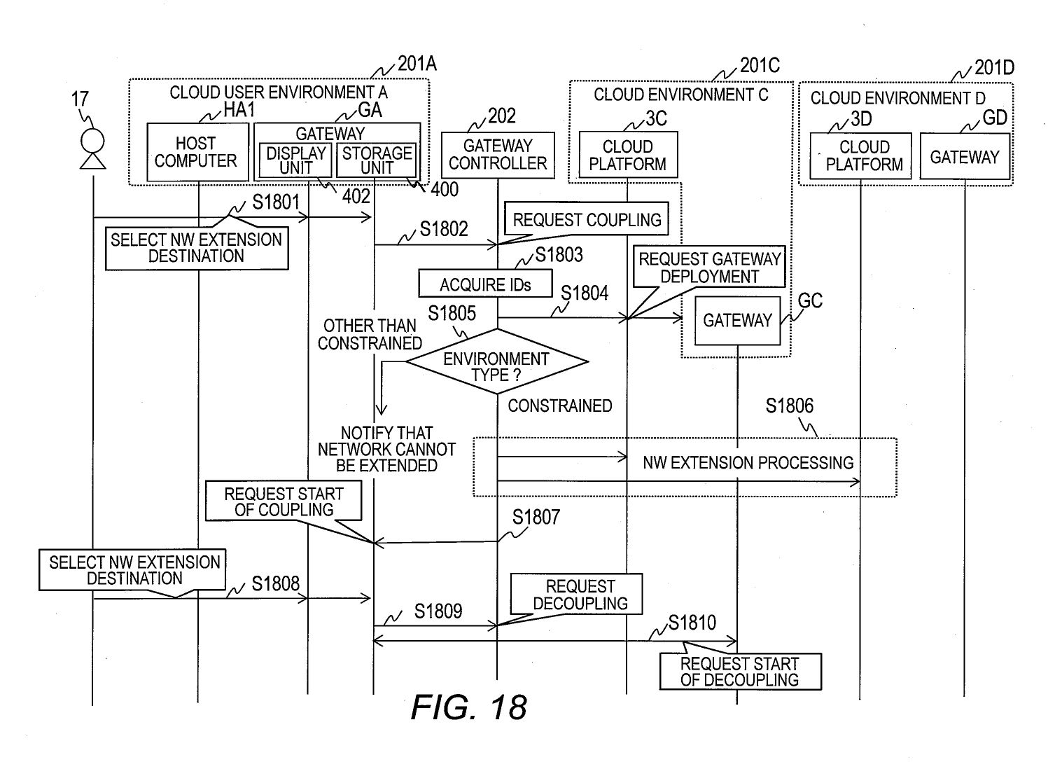

FIG. 17 and FIG. 18 are sequence diagrams each illustrating an example of a network extension sequence. FIG. 17 illustrates an example of the entire sequence in which a cloud user 17 acquires site network list information and host computer list information and selects a site network extension target via the gateway G. In FIG. 17, it is assumed that the cloud user environment 201A does not provide the management interface, such as the API, for notifying of the site network list information and the host computer list information and that the cloud environment 201C and the cloud environment 201D each provide the management interface such as the API. It is further assumed that the gateway GC is not deployed yet to the cloud environment 201C in this example.

Further, the virtual network management table 410 shown in FIG. 7 is created by the cloud user 17 operating the input unit 401 of the gateway GA prior to this sequence. The gateway GA transmits the created virtual network management table 410 to the gateway controller 202. In this manner, the virtual network management table 410 can be shared between the gateway GA and the gateway controller 202.

In Step S1701, the cloud user 17 operates the input unit 401 of the gateway GA to request the gateway GA to register site network information of the cloud user environment 201A, and the gateway GA caches the site network information. The site network information is, for example, information including the site network ID 803, site network name 804, site network address 805, site ID 1007, site name 1008, and site type 1009 of the cloud user environment 201A. In the case of the cloud user environment 201A, for example, the site network ID 803 is “SA1,” the site network name 804 is “N(SA1),” the site network address 805 is “A(SA1),” the site ID 1007 is “201A,” the site name 1008 is “Cloud User Environment A,” and the site type 1009 is “Cloud User Environment.”

In Step S1702, the host computer HA1 requests the gateway GA to register network address information of the host computer HA1. Specifically, for example, a user of the host computer HA1 operates the input unit 401 of the host computer HA1. to make this request. The network address information is information including the host computer ID 1212, the host computer name 1213, the MAC address 1214, and the IP address 1215. In the case of the host computer HA1, for example, the host computer ID 1212 is “HA1,” the host computer name 1213 is “N(HA1),” the MAC address 1214 is “MAC(HA1),” and the IP address 1215 is “IP(HA1).” The gateway GA then caches the network address information. Alternatively, the processing of Step S1702 may be processing in which the gateway GA requests the network address information from the host computer HA1.

In Step S1703, the gateway GA requests the gateway controller 202 to register the cached site network information and network address information. The gateway controller 202 stores the site network information and the network address information in the site network management table 411, site network-site association management table 413, site network-gateway association management table 414, and site network-host computer association management table 415 of the gateway controller 202.

Specifically, for example, the gateway controller 202 stores, from among the items of the site network information of the cloud user environment 201A, the site network ID 803, the site network name 804, and the site network address 805 in the site network management table 411 in association with one another.

Further, the gateway controller 202 stores, from among the items of the site network information of the cloud user environment 201A, the site network ID 803, the site ID 1007, the site name 1008, and the site type 1009 in the site network-site association management table 413 in association with one another.

Further, the gateway controller 202 stores the site network ID 803 included in the site network information of the cloud user environment 201A, “GA,” which is the gateway ID 1110 of the gateway GA as a requestor, and “N(GA),” which is the gateway name 1111 of the gateway GA in the site network-gateway association management table 414 in association with one another. It should be noted that the gateway ID 1110 and gateway name 1111 of the gateway GA may be acquired from the gateway GA in advance, or may be acquired from the gateway GA in Step S1703. Further, Step S1703 is executed regularly, or executed in response to a request from the gateway controller 202.

As described above, the cloud user environment 201A does not provide the management interface, such as the API, for notifying of the site network list and the host computer list, and hence the site network information of the cloud user environment 201A can be registered in the gateway controller 202 by the cloud user 17 operating the gateway GA. Further, the network address information is transmitted from the host computer HA1 to the gateway controller 202 via the gateway GA, and hence the gateway controller 202 can associate the network address information with the host computer HA1 of the site network information of the cloud user environment 201A.

In Step S1704, the cloud user 17 operates the gateway G to request, from the gateway controller 202, list information of the site networks S and list information of the gateways G and the host computers H. The list information of the site networks S corresponds to the entries of the site network management table 411, which is information that is held by the gateway controller 202 and has been collected from the respective sites 201.

Further, the list information of the gateways G and the host computers H corresponds to the network address information (assigned interface ID, MAC address, and IP address) of the gateways G and the host computers H. For example, in the case of the gateway G and the host computer H that are the virtual machines, this list information corresponds to the entries of the cloud network information management table 641 shown in FIG. 13. Further, in the case of the gateway G and the host computer H that are the physical machines, this list information corresponds to the network address information (assigned interface ID, MAC address, and IP address) of the gateways G and the host computers H that has been acquired by the gateway controller 202 from the gateways G that are the physical machine and has been acquired by each of the gateways G from the host computer H of its own site 201.

In Step S1705, in response to a request from the gateway G, the gateway controller 202 requests, from the cloud platform 3C and the cloud platform 3D, the list information of the gateways G and the host computers H.

In Step S1706, the gateway controller 202 acquires the list information of the gateways G and the host computers H that is held by the cloud platform 3C and the list information of the gateways G and the host computers H that is held by the cloud platform 3D. It should be noted that, as illustrated in FIG. 1B, the gateway controller 202 has already acquired the list information of the gateways G and the host computers H that are the physical machines, and hence Step S1706 for such list information is unnecessary. Further, as illustrated in FIG. 1B, the gateway controller 202 has already acquired the list information of the site networks S, and hence Step S1706 for such list information is unnecessary.

In Step S1707, when acquiring the list information of the gateways G and the host computers H from the cloud platform 3C and the cloud platform 3D in Step S1706, the gateway controller 202 updates the corresponding management tables. Specifically, for example, the gateway controller 202 compares the site network address 805 with the IP address 1319 of the host computer H to specify the site network ID 803 of the site network S to be coupled to the host computer H. In this manner, the gateway controller 202 adds, in the site network-host computer association management table 415, as a new entry, an entry including the specified site network ID 803, the instance ID 1316 of the host computer H, the IP address 1319, and the MAC address 1318 of the host computer H.

Further, the gateway controller 202 compares the site network address 805 with the IP address 1319 corresponding to the instance ID 1316 of the gateway G to specify the site network ID 803 of the site network S to be coupled to the gateway G. In this manner, the gateway controller 202 adds, in the site network-gateway association management table 414, as a new entry, an entry including the specified site network ID 803 and the instance ID 1316 of the gateway G.

In Step S1708, the gateway controller 202 extracts, from the site network management table 411 of the gateway controller 202, as the list information, the entries other than the ones for the site networks S that are coupled to the gateway GA as the requestor of the list information, and transmits this list information to the gateway GA. Further, the gateway controller 202 extracts, from the site network-site association management table 413 of the gateway controller 202, as the list information, the entries other than the ones for the site networks S that are coupled to the gateway GA as the requestor of the list information, and transmits this list information to the gateway GA.

Further, the gateway controller 202 extracts, from the site network-gateway association management table 414 of the gateway controller 202, as the list information, the entries other than the ones for the site networks S that are coupled to the gateway GA as the requestor of the list information, and transmits this list information to the gateway GA. Further, the gateway controller 202 extracts, from the site network-host computer association management table 415 of the gateway controller 202, as the list information, the entries other than the ones for the site networks S that are coupled to the gateway GA as the requestor of the list information, and transmits this list information to the gateway GA.

The gateway GA stores those pieces of list information transmitted from the gateway controller 202 in the site network management table 411, site network-site association management table 413, site network-gateway association management table 414, and site network-host computer association management table 415 of the gateway GA, and displays the list information on the display unit 402 to notify the cloud user 17 of the list information. In this manner, the gateway GA can acquire the network address information of the other sites 201.

In Step S1709, the cloud user 17 creates the virtual network-site network association management table 412. Specifically, for example, the cloud user 17 operates the input unit 401 of the gateway GA to call the virtual network management table 410 and the site network-site association management table 413 from the storage unit 400 so that those tables are displayed on the display unit 402. The cloud user 17 then associates the virtual network ID 701 with the site network ID 803 to create the virtual network-site network association management table 412 and stores the created table in the storage unit 400. In this manner, it is possible to prescribe which site network S belongs to which virtual network 300. It should be noted that the status 906 of the virtual network-site network association management table 412 is set to “Not Coupled” by default.

In Step S1710, the gateway GA transmits the created virtual network-site network association management table 412 to the gateway controller 202. The gateway controller 202 stores the virtual network-site network association management table 412 transmitted from the gateway GA in the storage unit 400.

Referring next to FIG. 18, FIG. 18 illustrates a sequence for coupling and decoupling by network extension.

In Step S1801, the cloud user 17 selects the network extension target. Specifically, for example, the cloud user 17 operates the input unit 401 of the gateway GA to refer to the virtual network management table 410 so that the list of the virtual network names is displayed on the display unit 402. The cloud user 17 then operates the input unit 401 of the gateway GA to select the network extension target from among the list of the virtual network names. For example, when checkboxes are arranged so as to correspond to the respective virtual network names, the cloud user 17 operates the input unit 401 of the gateway GA to check the checkbox of the virtual network name to be the network extension target. One or a plurality of the virtual network names can be selected.

In Step S1802, when the virtual network name to be the network extension target is selected, the gateway GA refers to the virtual network management table 410 to specify the corresponding virtual network ID 701. Further, the gateway GA refers to the virtual network-site network association management table 412 to specify the site network ID 803 that is associated with the identified virtual network ID 701 and has “Not Coupled” as the status 903. Specifically, for example, when “VN1” is selected as the virtual network ID 701 to be the network extension target, the gateway GA specifies, in FIG. 9, “SD,” which is the site network ID 803 having “Not Coupled” as the status 906. The gateway GA then notifies the gateway controller 202 of a coupling request including a combination of the specified virtual network ID 701 and site network ID 803.

In Step S1803, when receiving the notification of the coupling request, the gateway controller 202 refers to the site network ID 803 of the site network-site association management table 413 to acquire the site ID 1007 corresponding to the site network ID 803 included in the coupling request. For example, when the site network ID 803 included in the coupling request is “SA1,” the gateway controller 202 acquires “201A” as the site ID 1007.

Further, the gateway controller 202 refers to the site network-gateway association management table 414 to acquire the gateway ID 1110 associated with the site network ID 803 included in the coupling request.

In Step S1804, when the gateway controller 202 cannot acquire the gateway ID 1110, the gateway controller 202 requests the cloud platform 3 belonging to the site 201 having the acquired site ID 1007 to deploy the gateway G to the site network ID 803, to thereby build the gateway G as the virtual machine in the cloud platform 3. For example, the cloud platform 3C builds the gateway GC. Further, when the gateway GD of the cloud platform 3D is not deployed yet, the gateway GD is built as the virtual machine in a similar manner. In this manner, the cloud platform 3 creates the entry for the gateway G in the cloud network information management table 641. It should be noted that the interface ID 1317, MAC address 1318, and IP address 1319 of the created entry are not determined yet. In this manner, the gateway controller 202 acquires the gateway ID that is the instance ID 1316 from the deployed gateway G.

In Step S1805, the gateway controller 202 determines the site type 1009 of the site ID 1007 acquired in Step S1803. For the site ID 1007 having “Constrained Environment” as the site type 1009 (Step S1806: “CONSTRAINED”), in Step S1806, the gateway controller 202 executes network extension processing. For the site ID 1007 having the site type other than “Constrained Environment” (unconstrained environment or cloud user environment) as the site type 1009 (Step S1806: “OTHER THAN CONSTRAINED”), the network cannot be extended, and hence the gateway controller 202 notifies the gateway GA of this fact. The network extension processing of Step S1806 is described later.

After that, in Step S1807, the network is extended in Step S1806, and hence the gateway controller 202 transmits a coupling start request to the gateway GA that is the coupling requestor. Each of the gateway controller 202 and the gateway GA then updates, in its virtual network-site network association management table 412, the status 906 of the entry that has been selected as the network extension target from “Not Coupled” to “Being Coupled.” In this manner, as illustrated in FIG. 1A, the transmission and reception of the data are enabled between the cloud user environment and the cloud environment that is the constrained environment.

A description is next given of a case where the network extension target is decoupled. Also in the case of decoupling, in Step S1808, the cloud user 17 selects the network extension target to be a decoupling target similarly to the case of the coupling. Specifically, for example, the cloud user 17 operates the input unit 401 of the gateway GA to refer to the virtual network management table 410 so that the list of the virtual network names is displayed on the display unit 402. The cloud user 17 then operates the input unit 401 of the gateway GA to select the network extension target to be the decoupling target from among the list of the virtual network names. For example, when the checkboxes are arranged so as to correspond to the respective virtual network names, the cloud user 17 operates the input unit 401 of the gateway GA to check the checkbox of the virtual network name of the network extension target to be the decoupling target. One or a plurality of the virtual network names can be selected.

In Step S1809, when the virtual network name of the network extension target to be the decoupling target is selected, the gateway GA refers to the virtual network management table 410 to specify the corresponding virtual network ID 701. Further, the gateway GA refers to the virtual network-site network association management table 412 to specify the site network ID 803 that is associated with the identified virtual network ID 701 and has “Being Coupled” as the status 903.

Specifically, for example, when “VN1” is selected as the virtual network ID 701 to be the network extension target, the gateway GA specifies, in FIG. 9, “SA1” and “SC,” which are the site network IDs 803 each having “Being Coupled” as the status 906. The gateway GA then notifies the gateway controller 202 of a decoupling request including a combination of the specified virtual network ID 701 and site network ID 803.

In Step S1810, the gateway controller 202 transmits a decoupling start request to the gateway G corresponding to the site network S having the site network ID 803 included in the decoupling request. For example, when “SC” that is the site network ID 803 is specified, the gateway controller 202 refers to the site network-gateway association management table 414 to specify “GC,” which is the gateway ID 1110 corresponding to the site network SC.

Then, the gateway controller 202 transmits the decoupling start request for the site network SC to the gateway GC that is specified by “GC,” which is the specified gateway ID 1110. The gateway GC that has been received the decoupling start request decouples the site network SC. Specifically, the gateway GC and the gateway controller 202 each update the status 906 of the entry of the virtual network-site network association management table 412 that corresponds to the decoupling target from “Being Coupled” to “Not Coupled.”

### <Network Extension Processing (Step S1806)>

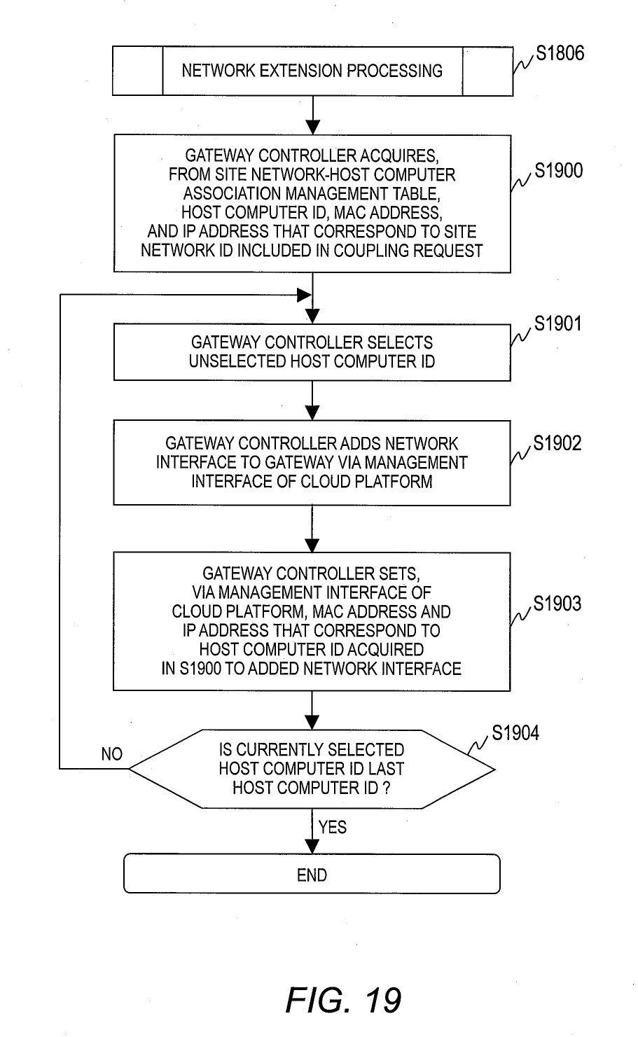

FIG. 19 is a flow chart illustrating an example of the network extension processing of Step S1806 illustrated in FIG. 18. In Step S1900, the gateway controller 202 acquires, from the site network-host computer association management table 415, the host computer ID 1212, the MAC address 1214, and the IP address 1215 that correspond to the site network ID 803 included in the coupling request. The site type 1009 of the information to be acquired is the unconstrained environment or the cloud user environment.

In Step S1901, the gateway controller 202 selects one host computer ID from among a group of the host computer IDs acquired in Step S1900.

In Step S1902, the gateway controller 202 adds, via the management interface of the cloud platform 3, the network interface to the gateway G of this cloud platform 3.

In Step S1903, the gateway controller 202 sets, to the network interface added to the gateway of the cloud platform 3, via the management interface of the cloud platform 3, the MAC address 1214 and the IP address 1215 that are associated with the host computer ID 1212 corresponding to the site network ID 803 included in the coupling request. Specifically, the gateway controller 202 sets, via the API of the cloud platform 3, to the entry of the cloud network information management table 641, the MAC address 1214 and the IP address 1215 that are associated with the host computer ID 1212 corresponding to the site network ID 803, and the network interface ID 1317 to be assigned with the MAC address 1214 and the IP address 1215.

For example, in the case of FIG. 13, in the entry of the gateway GD, the MAC address and IP address of the host computer HA1 are assigned to an interface IFD1-2 of the cloud platform 3D, and the MAC address and IP address of the host computer HA2 are assigned to an interface IFD1-3 of the cloud platform 3D. It should be noted that a MAC address and an IP address for connecting to a public network are assigned to the interface IFD1-1.

In Step S1904, when it is determined that the host computer ID selected in Step S1901 is the last host computer ID (S1904:Yes), the gateway controller 202 ends this flow, and then executes Step S1807. When it is determined that the host computer ID selected in Step S1901 is not the last host computer ID (S1904:No), the flow returns to Step S1901.

In the manner described above, the MAC addresses and IP addresses of the host computers HA1 and HA2 within the cloud user environment 201A are set to the gateway GD of the cloud environment 201D that is the constrained environment.

As described above, according to the first embodiment, it is possible to provide the network extension across the cloud user environment and the constrained environment. Further, even when the gateway G is not deployed to the network extension target, the gateway controller 202 automatically deploys the gateway G to the site network S of the extension target via the management interface of the cloud platform 3.

The deployed gateway G executes the autonomous learning to acquire the network address information of the host computer H and site network S of its own site 201 and the network address information of the gateway G itself, and hence the gateway controller 202 can collect the thus acquired network address information. In this manner, it is possible to provide the network extension across the cloud user environment and the constrained environment after the gateway G is deployed thereto.

### Second Embodiment

In the first embodiment, the MAC address and IP address of the host computer H are set to the network interface of the gateway deployed to the cloud environment that is the constrained environment, and hence the maximum number of host computers from which the network can be extended from among a group of host computers other than those of the constrained environment is the same as the maximum number of interfaces of the gateway of the constrained environment.

In a second embodiment, a description is given of an example in which the networks of the host computers H whose number exceeds the number of interfaces of the gateway are extended. The overall configuration of a system, a gateway controller, and a cloud platform are the same as those of the first embodiment, and hence a description thereof is omitted.

The gateway has a network address conversion processing program in addition to the functions of the first embodiment. The gateway executes, based on a conversion rule requested by the gateway controller, address conversion processing on a destination network address and source network address of communication. This processing is merely an example, and the network address conversion processing program may be implemented by other known methods such as OpenFlow, or a proprietary method as long as the method to be applied is the function of network address conversion processing.

It should be noted that, in the first embodiment, the gateway controller collects the network address information of the respective sites, but the gateway may collect, from the gateways of the other sites, the network address information of the other sites that has been acquired by the other sites. In this manner, when an autonomous sharing function is used among the gateways, any one of the gateways functions as the gateway controller. Alternatively, a virtual machine of the gateway controller may be built in one of the cloud platforms.

### <Network Extension Example>

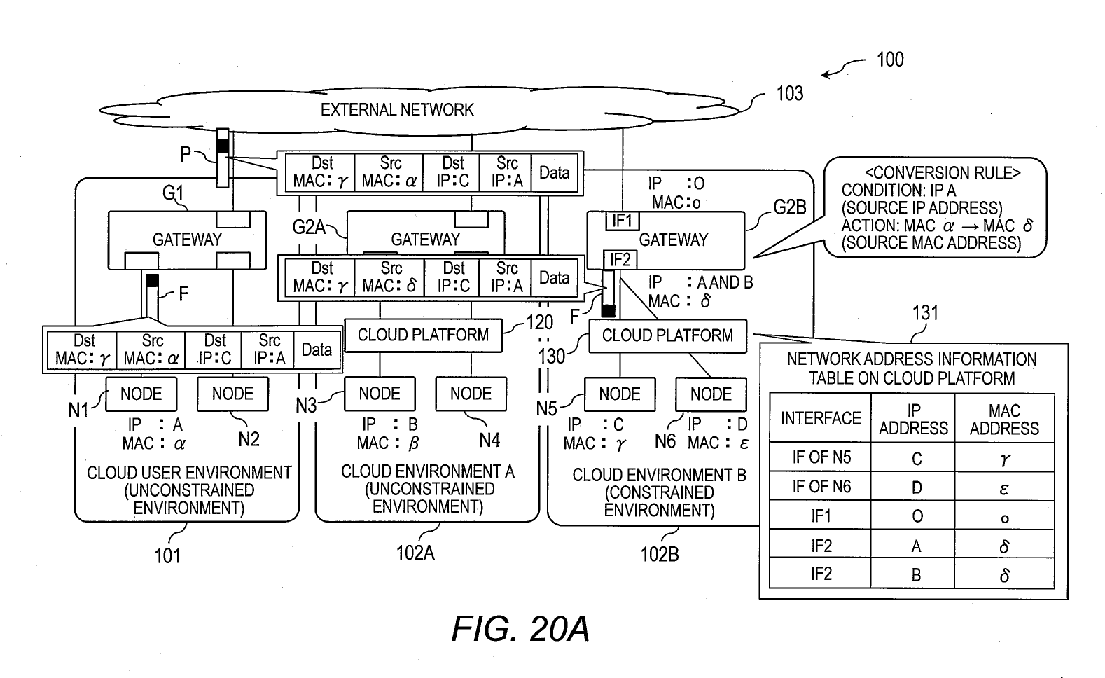

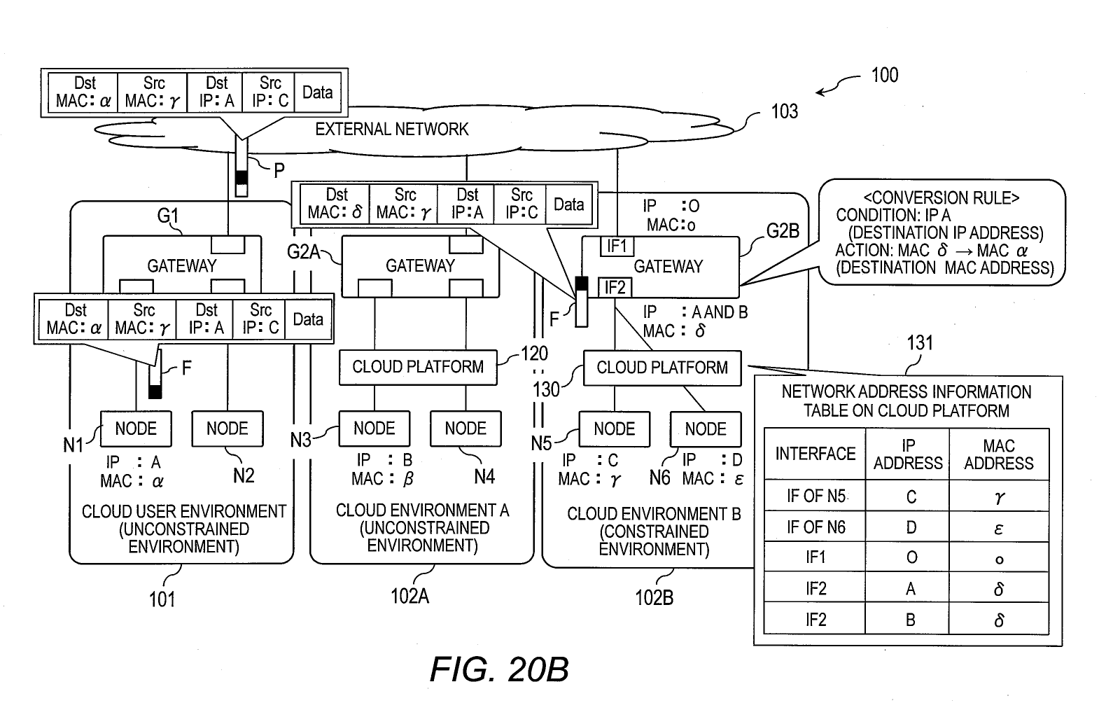

FIG. 20A is an explanatory diagram illustrating Network Extension Example 1 according to the second embodiment. In FIG. 20A, a description is given by taking as an example a case where data is unicast from the node under the cloud user environment to the node under the constrained environment. The same components as those of FIG. 1A are denoted with the same reference numerals or symbols, and a description thereof is omitted. The data F transmitted from the node N1 of the cloud user environment 101 is encapsulated by the gateway G1 to become the data P. The data P passes through the external network 103 to reach the gateway G2B and the data P is then decapsulated to become the data F. In the gateway G2B, the above-mentioned conversion rule is set. In the conversion rule, for example, when the source IP address of the data F received from the external network 103 is a specific IP address (in this example, IP address: A), the source MAC address of the data received from the external network 103 is converted into a specific MAC address (in this example, MAC address: δ). The converted data F reaches the node N5.

It should be noted that, as a presetting, the cloud platform 130 acquires, through collection of the network address information illustrated in FIG. 1B, a combination of the specific IP address and the specific MAC address (A, δ) from the gateway controller 140, holds this combination in the network address information table 131, and assigns those addresses to the interface IF2 of the gateway G2B. In this manner, the node N5 under the constrained environment can receive the data from the node N1 under the unconstrained environment.

FIG. 20B is an explanatory diagram illustrating Network Extension Example 2 according to the second embodiment. FIG. 20B illustrates an example in which, in FIG. 20A, the data is unicast from the node N5 of the constrained environment to the node N1 of the cloud user environment. The same components as those of FIG. 20A are denoted with the same reference numerals or symbols, and a description thereof is omitted.

The network address information table of the cloud platform 130 is the same as that of FIG. 20A, but a conversion rule of the gateway G2B differs from that of FIG. 20A. In this conversion rule, for example, when the destination IP address of the data received in its own site is a specific IP address (in this example, IP address: A), the destination MAC address of the data received in its own site is converted into a specific MAC address (in this example, MAC address: α).

For example, the destination IP address of the data transmitted from the node N5 is “A” and the destination MAC address thereof is “δ,” and hence a combination of those addresses exists in the network address information table. The data transmitted from the node N5 therefore passes through the cloud platform 130 to reach the interface IF2 of the gateway G2B. The gateway G2B converts the destination MAC address from “δ” into “α” because, in accordance with the conversion rule, the destination IP address of the data received by the interface IF2 from the node N5 corresponds to the specific IP address “A.”

This converted data is encapsulated and passes through the external network and the gateway G1, and is then decapsulated to reach the node N1. In this manner, the node N1 of the cloud user environment can receive the data from the node N5 of the constrained environment. Now, a detailed description is given of contents of the second embodiment with a focus on a difference from the first embodiment.

### <Cloud Network Information Management Table 641>

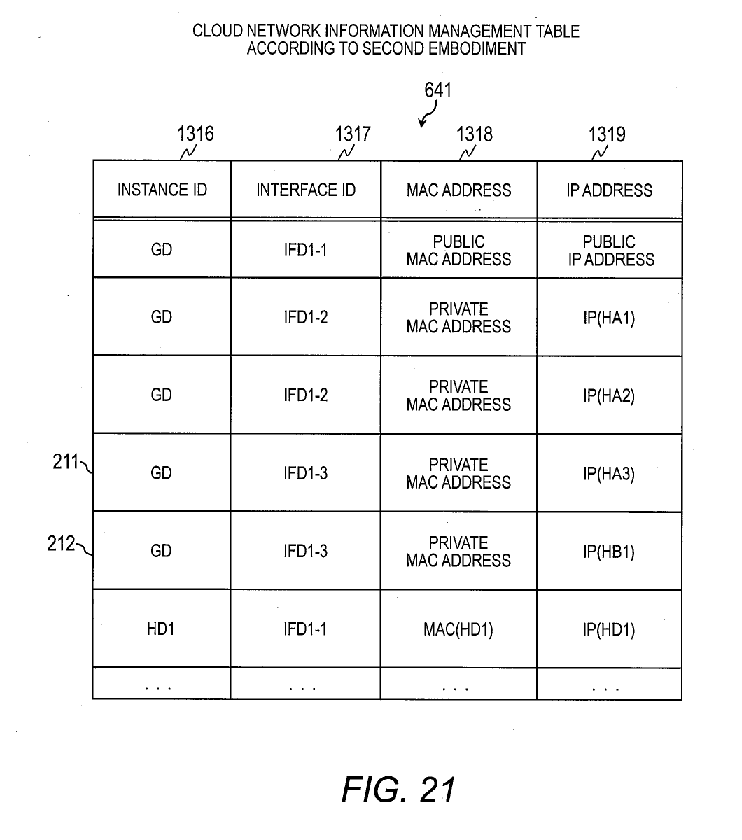

FIG. 21 is an explanatory diagram showing an example of the cloud network information management table 641 according to the second embodiment. Among the components of FIG. 21, a description of components denoted with the same reference numerals as those of FIG. 13 of the first embodiment is omitted. In the second embodiment, the cloud platform 3 registers, in the network interface of the gateway G on the site network S side of its own site, one or more IP addresses of the host computers H other than those of the cloud environment. Further, the MAC address may be the MAC address of the host computer, or may be another arbitrary MAC address.

For example, in entries 211 and 212 of FIG. 21, the network interface of the gateway G whose interface ID 1317 is “IFD1-3” is the interface coupled to the site network S of its own site. A private MAC address is registered in the MAC address 1318 of each of the entries 211 and 212.

When the gateway GD whose gateway ID as the instance ID 1316 is “GD” is the gateway G2B of FIGS. 20A and 20B, the MAC address 1318 of each of the entries 211 and 212 is “δ.” In addition, the IP address “IP(HA3)” of the host computer HA3, which is the IP address 1319 of the entry 211, is the IP address “A” of the node N1 of FIGS. 20A and 20B. Similarly, the IP address “IP(HB1)” of the host computer HB1, which is the IP address 1319 of the entry 212, is the IP address “B” of the node N3 of FIGS. 20A and 20B.

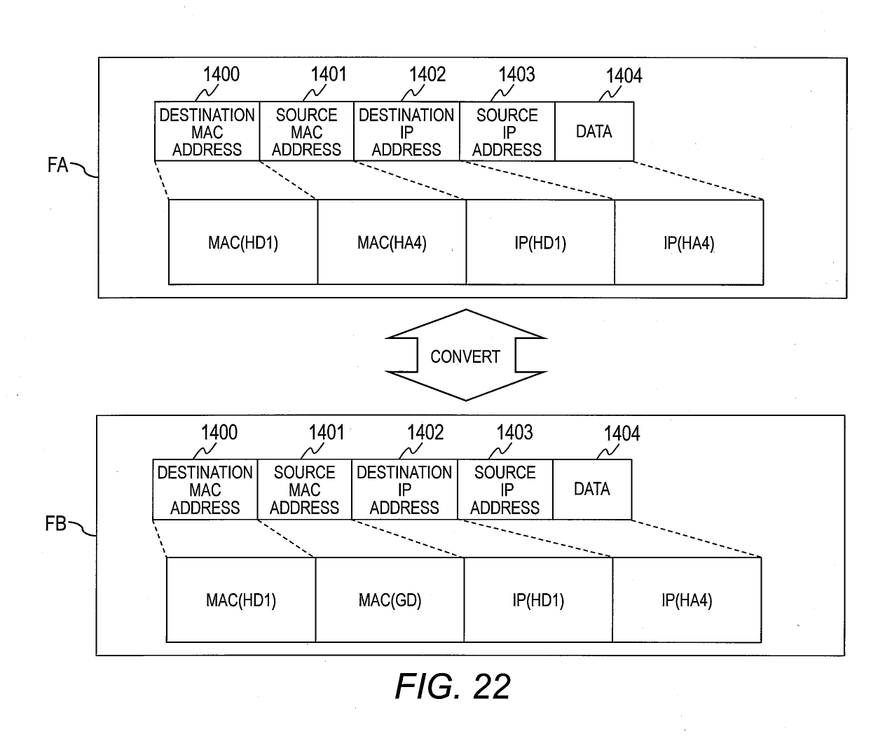

FIG. 22 is an explanatory diagram illustrating an example of data structures before and after communication address conversion according to the second embodiment. Among the components of FIG. 22, a description of components that are described above and denoted with the same reference numerals as those of FIG. 14 is omitted. When data is communicated from the host computer HA4 of the cloud user environment 201A to the host computer HD1 of the cloud environment 201D that is the constrained environment, data FA is data before conversion and data FB is data after conversion. On the other hand, when data is communicated from the host computer HD1 of the cloud environment 201D that is the constrained environment to the host computer HA4 of the cloud user environment 201A, the data FB is the data before conversion and the data FA is the data after conversion.

In the second embodiment, for example, in a case where the data is communicated from the host computer HA4 of the cloud user environment 201A to the host computer HD1 of the cloud environment 201D that is the constrained environment, the source MAC address 1401 of the data FA before being encapsulated is the MAC address of the host computer HA4 of the cloud user environment 201A.

In the cloud environment 201D that is the constrained environment, when the source MAC address after being decapsulated is the MAC address of the host computer HA4, this MAC address is not registered in the cloud network information management table 641, and hence the data FA is discarded. When the source IP address 1403 is the IP address of the host computer HA4, by executing address conversion processing of converting the source MAC address 1401 from the MAC address of the host computer HA4 into the MAC address of the gateway GD, the gateway GD can transfer the data FB obtained by the conversion.

Further, in a case where the data is communicated from the host computer HD1 of the cloud environment 201D that is the constrained environment to the host computer HA4 of the cloud user environment 201A, when the destination IP address is the IP address of the host computer HA4, the gateway GD of the cloud environment 201D that is the constrained environment executes address conversion processing of converting the destination MAC address 1400 of the data FB from the host computer HD1 from the MAC address of the gateway GD into the MAC address of the host computer HA4 of the cloud user environment 201A. FIG. 22 illustrates, as an example, the communication between the cloud user environment and the constrained cloud environment, but instead of the cloud user environment, the cloud environment of the unconstrained environment is also applicable.

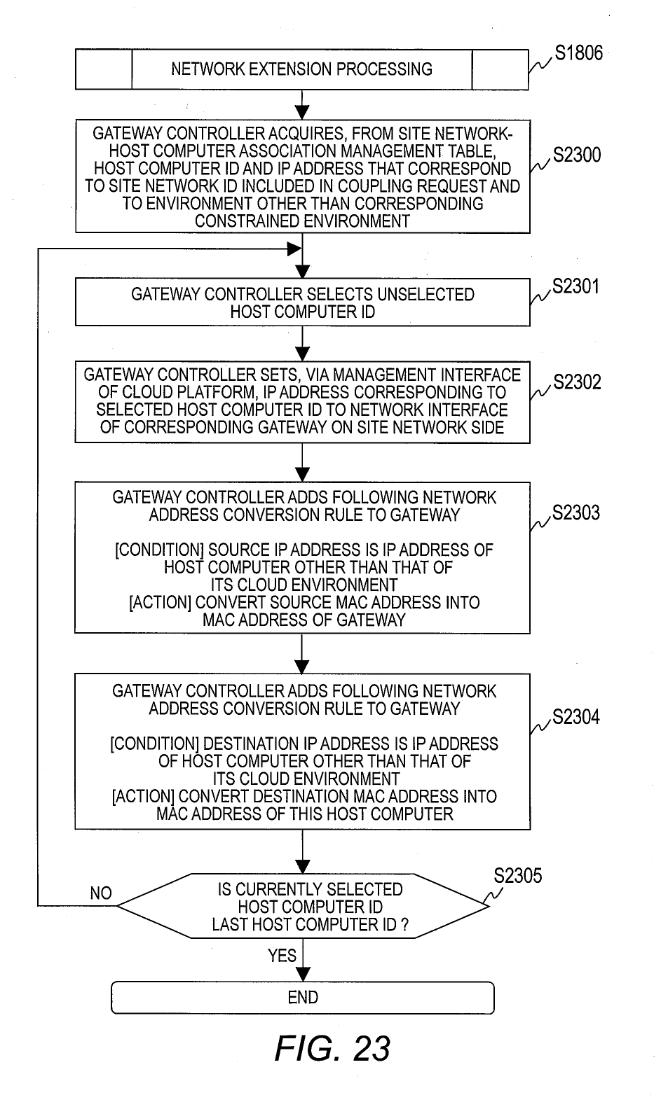

FIG. 23 is an explanatory diagram illustrating an example of a network extension flow according to the second embodiment. FIG. 23 illustrates detailed processing of the second embodiment in the network extension processing of Step S1806 of FIG. 18.

In Step S2300, the gateway controller 202 refers to the column of the site network ID 803 of the site network-host computer association management table 415, which is shown in FIG. 12, to acquire the host computer ID 1212 and the IP address 1215 that correspond to the site network ID included in the coupling request of Step S1802 and to the environment (unconstrained environment or cloud user environment) other than the corresponding constrained environment.

In Step S2301, the gateway controller 202 selects one host computer ID from among a group of the host computer IDs acquired in Step 2300.

In Step S2302, the gateway controller 202 sets, via the cloud platform 3, the IP address corresponding to the host computer ID selected in Step 2301 to the network interface of the corresponding gateway G on the site network S side. It should be noted that, as the MAC address corresponding to the IP address, the MAC address (for example, private MAC address) of the corresponding gateway is set.

In Step S2303, the gateway controller 202 sets, to the gateway GD, the following communication address conversion rule: “When the source IP address of data is the host computer H of the cloud user environment 201A (may also be 201B) (Condition), the source MAC address of the data is converted into the MAC address of the gateway G (Action).” Specifically, for example, the conversion rule is added as illustrated in FIGS. 20A and 20B.

In Step S2104, the gateway controller 202 sets, to the gateway GD, the following communication address conversion rule: “When the destination IP address of data is the host computer H of the cloud user environment 201A (may also be 201B) (Condition), the destination MAC address is converted into the MAC address of this host computer H (Action).”

In Step S2105, when it is determined that the host computer ID selected in Step S2301 is the last host computer ID, the gateway controller 202 ends this flow, and then executes Step S1807. When it is determined that the host computer ID selected in Step S2301 is not the last host computer ID, the flow returns to Step S2301.

As described above, according to the second embodiment, by executing the communication address conversion processing on the source address or destination address of the data received by the gateway G of the constrained environment, it is possible to extend the networks of the host computers H whose number exceeds the number of interfaces of the gateway G. It is therefore possible to achieve an increase in the scale of network extension.

As described above, according to this embodiment, it is possible to provide the network extension across the cloud user environment and the constrained environment. Specifically, the data from the cloud user environment is otherwise discarded by the access control function of the cloud platform within the cloud environment that is the constrained environment, but under the management of the gateway controller, the gateway controller makes such a setting as to prevent the data flowing between the cloud user environment and the cloud environment from being discarded by the access control function of the cloud platform. With this, the cloud user can extend the site network of his/her own cloud user environment to the site network within the cloud environment that is the constrained environment. When the communication counterpart of the cloud environment that is the constrained environment is another cloud environment that is the unconstrained environment, it is also possible to realize the network extension in a similar manner.

Further, even when the gateway is not deployed to the network extension target, by automatically deploying the gateway to the site network of this extension target via the management interface of the cloud platform, the gateway controller can collect the network address information acquired by this deployed gateway. With this, it is possible to provide the network extension across the cloud user environment and the constrained environment after the gateway is deployed thereto.

Further, by executing the communication address conversion processing on the source address or destination address of the data received by the gateway of the constrained environment, it is possible to extend the networks of the host computers whose number exceeds the number of interfaces of the gateway. It is therefore possible to achieve an increase in the scale of network extension.

Further, to collect the network address information within the respective sites, the gateway controller may collect the network address information to manage the collected network address information in a centralized manner. Alternatively, the respective gateways may collect the network address information so that the collected network address information is autonomously shared among the gateways. Still further, the above-mentioned site network is applicable to a layer (L) 2 network and an L3 network.

It should be noted that the present disclosure is not limited to the embodiments described above, and encompasses various modification examples and the equivalent configurations within the scope of the appended claims without departing from the gist of the present disclosure. For example, the above-mentioned embodiments are described in detail for a better understanding of the present disclosure, and the present disclosure is not necessarily limited to what includes all the configurations that have been described. Further, a part of the configurations according to the embodiment may be added to, deleted from, or replaced by another configuration.

Further, a part or entirety of the respective configurations, functions, processing modules, and the like that have been described may be implemented by hardware, for example, may be designed as an integrated circuit, or may be implemented by software by a processor interpreting and executing programs for implementing the respective functions.

The information on the programs, tables, files, and the like for implementing the respective functions can be stored in a storage device such as a memory, a hard disk drive, or a solid state drive (SSD) or a recording medium such as an IC card, an SD card, or a DVD.

Further, control lines and information lines that are assumed to be necessary for the sake of description are described, but not all the control lines and information lines that are necessary in terms of implementation are described. It may be considered that almost all the components are connected to one another in actuality.

Although the present disclosure has been described with reference to exemplary embodiments, those skilled in the art will recognize that various changes and modifications may be made in form and detail without departing from the spirit and scope of the claimed subject matter.

What is claimed is:

1. A network extension system configured to couple a first network system in which a first gateway and a first host computer are capable of communicating to and from each other to a second network system in which a second gateway and a second host computer are capable of communicating to and from each other,
the second network system comprising a management apparatus configured to, when network address information of a transmission source of first data from outside of the second network system is not set to an interface that is coupled to the second host computer among a group of interfaces of the second gateway, discard the first data, and when network address information of a destination of second data from the second host computer is not set to the interface that is coupled to the second host computer among the group of interfaces of the second gateway, discard the second data,
the network extension system comprising a control apparatus configured to control the management apparatus,
the control apparatus being configured to execute:
acquisition processing of acquiring network address information of the first host computer; and
assignment processing of controlling the management apparatus to assign the network address information of the first host computer that has been acquired in the acquisition processing to the interface that is coupled to the second host computer among the group of interfaces of the second gateway.

2. The network extension system according to claim 1, wherein the control apparatus is configured to:
acquire, in the acquisition processing, an IP address of the first host computer;
assign, in the assignment processing, a combination of the IP address of the first host computer that has been acquired in the acquisition processing and a specific MAC address to the interface that is coupled to the second host computer among the group of interfaces of the second gateway; and
execute setting processing of setting, to the second gateway, a conversion rule of converting, when a source IP address of data from the outside of the second network system is the IP address of the first host computer, a source MAC address of the data from a MAC address of the first host computer into the specific MAC address.

3. The network extension system according to claim 1, wherein the control apparatus is configured to:
acquire, in the acquisition processing, an IP address of the first host computer;
assign, in the assignment processing, a combination of the IP address of the first host computer that has been acquired in the acquisition processing and a specific MAC address to the interface that is coupled to the second host computer among the group of interfaces of the second gateway; and
execute setting processing of setting, to the second gateway, a conversion rule of converting, when a destination IP address of data from the second host computer is the IP address of the first host computer, a destination MAC address of the data from the specific MAC address into a MAC address of the first host computer.

4. The network extension system according to claim 1, wherein when the second gateway does not exist in the second network system, the control apparatus builds a virtual machine of the second gateway within the management apparatus.

5. The network extension system according to claim 1, wherein the control apparatus executes the assignment processing in response to a request from the first network system.

6. The network extension system according to claim 1, wherein the first network system comprises a network system of a user who uses the second network system.

7. The network extension system according to claim 1, wherein the first network system comprises a network system to be used by a user who uses the second network system.

8. A control apparatus to be coupled to a network extension system configured to couple a first network system in which a first gateway and a first host computer are capable of communicating to and from each other to a second network system in which a second gateway and a second host computer are capable of communicating to and from each other,
the control apparatus being configured to:
control a management apparatus arranged in the second network system and configured to, when network address information of a transmission source of first data from outside of the second network system is not set to an interface that is coupled to the second host computer among a group of interfaces of the second gateway, discard the first data, and when network address information of a destination of second data from the second host computer is not set to the interface that is coupled to the second host computer among the group of interfaces of the second gateway, discard the second data; and
execute:
acquisition processing of acquiring network address information of the first host computer; and
assignment processing of controlling the management apparatus to assign the network address information of the first host computer that has been acquired in the acquisition processing to the interface that is coupled to the second host computer among the group of interfaces of the second gateway.

9. A network extension method to be executed by a network extension system configured to couple a first network system in which a first gateway and a first host computer are capable of communicating to and from each other to a second network system in which a second gateway and a second host computer are capable of communicating to and from each other,
the second network system comprising a management apparatus configured to, when network address information of a transmission source of first data from outside of the second network system is not set to an interface that is coupled to the second host computer among a group of interfaces of the second gateway, discard the first data, and when network address information of a destination of second data from the second host computer is not set to the interface that is coupled to the second host computer among the group of interfaces of the second gateway, discard the second data,
the network extension system comprising a control apparatus configured to control the management apparatus,
the network extension method comprising executing, by the control apparatus:
acquiring network address information of the first host computer; and
controlling the management apparatus to assign the acquired network address information of the first host computer to the interface that is coupled to the second host computer among the group of interfaces of the second gateway.
